(19) United States
(12) Patent Application Publication
(10) Pub. No.: US 2008/0105663 A1
(43) Pub. Date: May 8, 2008

(54) METHOD FOR FORMING NANOSCALE FEATURES AND STRUCTURES PRODUCED THEREBY

(75) Inventors: Alan J. Hunt, Plymouth, MI (US); Ernest F. Hasselbrink JR., Saline, MI (US); Edgar Meyhofer, Ann Arbor, MI (US); Kevin Ke, Temple City, CA (US)

Correspondence Address: HARNESS, DICKEY & PIERCE, P.L.C., P.O. BOX 828, BLOOMFIELD HILLS, MI, 48303, US

(73) Assignee: THE REGENTS OF THE UNIVERSITY OF MICHIGAN, Ann Arbor, MI (US)

(21) Appl. No.: 11/927,764

(22) Filed: Oct. 30, 2007

Related U.S. Application Data
(62) Division of application No. 10/988,333, filed on Nov. 11, 2004.
Application No. 10/988,333 is a continuation-in-part of application No. 10/765,656, filed on Jan. 26, 2004, now Pat. No. 6,995,336.
(60) Provisional application No. 60/443,431, filed on Jan. 29, 2003.

(51) Int. Cl. B23K 26/36; B23K 26/14

(52) U.S. Cl. 219/121.69

(57) ABSTRACT

The invention provides a versatile technique for machining of nanometer-scale features using tightly-focused ultrashort laser pulses. By the invention, the size of features can be reduced far below the wavelength of light, thus enabling nanomachining of a wide range of materials. The features may be extremely small, of nanometer size, and are highly reproducible.

### CROSS-REFERENCE TO RELATED APPLICATIONS

This application is a divisional of U.S. patent application Ser. No. 10/988,333 filed on Nov. 11, 2004, which is a continuation-in-part of U.S. Pat. No. 6,995,336 issued on Feb. 7, 2006, which claims the benefit of U.S. Provisional Application No. 60/443,431 filed on Jan. 29, 2003. The disclosures of the above applications are incorporated herein by reference.

### FIELD OF THE INVENTION

This invention relates generally to methods utilizing lasers for modifying internal and external surfaces of material such as by ablation or changing properties in structure of materials. This invention may be used for a variety of materials.

### BACKGROUND OF THE INVENTION

Laser induced breakdown of a material causes chemical and physical changes, chemical and physical breakdown, disintegration, ablation, and vaporization. Lasers provide good control for procedures which require precision such as inscribing a micro pattern. Pulsed rather than continuous beams are more effective for many procedures, including medical procedures. A pulsed laser beam comprises bursts or pulses of light which are of very short duration, for example, on the order of 10 nanoseconds in duration or less. Typically, these pulses are separated by periods of quiescence. The peak power of each pulse is relatively high often on the order of gigawatts and capable of intensity on the order of 10¹³ w/cm² or higher. Although the laser beam is focused onto an area having a selected diameter, the effect of the beam extends beyond the focused area or spot to adversely affect peripheral areas adjacent to the spot. Sometimes the peripheral area affected is many times greater than the spot itself. This presents a problem, particularly when high precision is required, or where tissue is affected in a medical procedure. In the field of laser machining, current lasers using nanosecond pulses cannot produce features with a high degree of precision and control, particularly when nonabsorptive wavelengths are used.

In U.S. Pat. No. 5,656,186, Mourou et al., provided a method to localize laser induced breakdown, and provided a method to induce breakdown in a preselected pattern in a material or on a material. In U.S. Pat. No. 5,235,606, Mourou et al., described a CPA (chirped-pulse amplification) system for use in such method.

Mourou et al. showed that when matter is subjected to focused high-power laser pulses localized plasmas are generated by optical breakdown. More specifically, the Mourou U.S. Pat. No. 5,656,186 showed a method for laser induced breakdown of a material with a pulsed laser beam where the material is characterized by a relationship of fluence breakdown threshold (Fₜₕ) versus laser beam pulse width (T) that exhibits an abrupt, rapid, and distinct change or at least a clearly detectable and distinct change in slope at a predetermined laser pulse width value. The method comprises generating a beam of laser pulses in which each pulse has a pulse width equal to or less than the predetermined laser pulse width value. The beam is directed to a material where laser induced breakdown is desired. The technique can produce features smaller than the spot size and Rayleigh range due to enhanced damage threshold accuracy in the short pulse regime.

Mourou et al. departs from the conventional thinking concerning optically induced dielectric breakdown relationship to pulse duration, demonstrating the dependence weakening below certain pulse width value. The small pulse energy and short pulse duration associated with optical breakdown according to Mourou prevents collateral damage from heating, and associated undesirable mechanical phenomena.

A major barrier to creating nanotechnology is that fabrication of nanometer scale features requires complex processes. Ultrashort pulsed lasers have demonstrated potential for fabricating sub-micron features in diverse substrates by taking advantage of the sharp boundaries of optical breakdown created by femtosecond pulses of laser light. The present invention reveals a new method for providing a new mechanism for optical breakdown.

### SUMMARY OF THE INVENTION

The present invention enables a new regime of robust, ultra-high-precision laser machining (UHPLM) where features are reduced by more than an order of magnitude. Here is presented a versatile technique for machining of nanometer-scale features using tightly-focused ultrashort laser pulses. By the invention, the size of features can be reduced far below the wavelength of light, thus enabling nanomachining of a wide range of materials. The features may be extremely small (<20 nm), are highly reproducible and are independent of the polarization of the light. This generalized process for nanoscale machining holds great promise for applications including MEMS construction and design, microelectronics, fabricating optical wave-guides and memory, microfluidics, materials science, microsurgery, and creating structures to interface with cells and biological molecules. The present invention will also anticipate significant impact in the biological sciences, enabling targeted disruption of nanoscale cellular structures and genetic material.

The present invention achieved two orders of magnitude further reduction in optical breakdown pulse energy by carefully approaching the threshold energy at the small (˜400 nm) focal spot produced by high numerical aperture (NA) objectives.

This reduction arises not by further decreases in pulse widths, but by decreasing the focal spot size using high numerical aperture objectives, and carefully controlled approach to the optical damage energy threshold. The reduction of the photodisrupted zone size from the initial nanosecond studies to work by the present invention is at least three orders of magnitude, and here is shown to be over five orders of magnitude.

Radiation damage beyond the region of optical breakdown is insignificant because the extremely short duration of a pulse; the total energy delivered is negligible in regions where the intensity is insufficient to produce nonlinear events. For comparison, the energy delivered to a cell in one second during conventional differential interference contrast microscopy (DIC) is on the order of millijoules. The relatively delicate cell easily survives this, and this is vastly more energy than is used by the present invention for UHPLM; optical breakdown at nanometer dimensions requires about a nanojoule of energy, a difference of over six orders of magnitude. Likewise, although femtoseconds pulses can induce apoptosis-like death in mammalian cells due to generation of reactive oxygen species, this requires cells to be exposed to ˜320×10⁶ pulses, each ˜90 pJ, or about 28 mJ of laser energy (Konig et al., 1999; Tirlapur et al., 2001). This is more than seven orders of magnitude more energy than that delivered for UHPLM, where features are induced by a single laser pulse.

Thus, it is shown here that the laser intensity can be selected so that only a small section across the beam, even at a diffraction limited focus, exceeds the required intensity for optical breakdown (as shown in FIGS. 1, 2 and 3). This “thresholding” effect can be exploited because of the deterministic nature of optical breakdown observed for sub-picosecond pulses. Here the energy is highly focused and extremely close to threshold pulse energy for optical breakdown (˜5%), yet even at the most minute scales (<20 nm), the holes have sharply delineated edges and are highly reproducible. This indicates a virtually deterministic dependence on pulse energy and laser intensity, so that only a small, sharply defined section of even a gaussian diffraction-limited focus exceeds the required breakdown intensity. There is a non-linear relation so that the breakdown probability shows a very high order dependence on the light energy.

In one aspect, the beam is focused by selecting a numerical aperture objective for focusing sufficient to define a spot in or on the material so that the desired feature size is obtained when laser-induced optical breakdown causes ablation of an area less than about 10% of the area of the spot. The beam is directed to a point at or beneath the surface of a material where laser induced breakdown is desired. Preferably the new numerical aperture objective is selected to define an area such that the desired feature size may be obtained when not less than 1% of the area of a gaussian diffraction-limited focus exceeds energy density equal to or greater than the threshold.

In one aspect, the ablation forms a feature having a maximum dimension which is over an order of magnitude smaller than the wavelength of the light. Desirably a plurality of features are formed in the material characterized by a variability in the largest dimension which is less than 10%. Preferably a plurality of features are formed in the material characterized by a variability in the largest dimension which is less than 5%.

Desirably the wavelength is in a range of 400 to 600 nanometers, more desirably the wavelength is in a range of 500 to 550 nanometers, and preferably the wavelength is 527 nanometers. Desirably the feature is less than 250 nanometers; more desirably less than 100 nanometers; and preferably 20 nanometers or less; and most preferably 16 nanometers or less.

Desirably the pulse width is a picosecond or less. Preferably the pulse width is 600 femtoseconds.

In one aspect, the focusing objective is an oil immersion objective lens.

The method is operable for essentially any material, transparent, opaque, biologic, tissue, glass, and metal.

In one aspect, the invention may be understood by further defining the damage threshold energy density: the laser energy delivered to an area must exceed a sharply defined threshold to cause material damage/ablation. This threshold is related to, but not the same, as the threshold fluence for ionization and the fluence breakdown threshold. The threshold energy density is invariant across a material, even at the nanometer scale, and it is this aspect that enable ultra-high-precision laser machining of reproducible nanoscale features with sharply-defined edges.

In one aspect, the method of the invention provides a laser beam which defines a spot that has a lateral gaussian profile characterized in that fluence at or near the center of the beam spot is greater than the damage threshold energy density whereby the laser induced breakdown is ablation of an area within the spot. The maximum intensity is at the very center of the beam waist. The beam waist is the point in the beam where wave-front becomes a perfect plane; that is, its radius of curvature is infinite. This center is at radius R=0 in the x-y axis and along the Z axis, Z=0. This makes it possible to damage material in a very small volume centered on Z=0, R=0. Thus it is possible to make features smaller than spot size in the x-y focal plane and smaller than the Rayleigh range (depth of focus) in the Z axis. It is preferred that the pulse width duration be in the femtosecond range although pulse duration of higher value may be used so long as the value is less than the pulse width defined by an abrupt or discernable change in slope of fluence breakdown threshold versus laser beam pulse width.

In one aspect, the method of the invention provides a laser beam which defines a spot that has a lateral profile characterized in that fluence varies within the beam spot and is greater than the damage threshold energy density whereby the laser induced breakdown is ablation of an area within the spot. The intensity peak or peaks are distributed across the beam waist. The beam waist is the point in the beam where wave-front becomes a perfect plane; that is, its radius of curvature is infinite.

It is preferred that the beam have an energy in the range of 3 nJ (nanojoules) to 3 microjoule and that the beam have a fluence in the range of 2 J/cm² to 2000 J/cm² (joules per centimeter square). It is preferred that the wavelength be in a range of 350 nm (nanometers) to 1.1 μm (micron).

As can be seen, the present invention takes a new approach as compared to the prior work of U.S. Pat. No. 5,656,186, Mourou et al., which showed that when matter is subjected to focused high-power laser pulses localized plasmas are generated by optical breakdown. As shown in this present invention, optical breakdown proceeds by Zener ionization followed by a combination of Zener and Zener-seeded avalanche ionization, in which initial (seed) unbound electrons in the target material are accelerated by the extreme electric field of a short pulse laser to create a cascade of free electrons through collisions. This even occurs in transparent materials, which become opaque light absorbers above a certain irradiance threshold. Optical breakdown shows a highly non-linear dependence on intensity. This non-linearity makes it possible to limit optical breakdown to regions smaller than the spot-size of the focused laser; the laser power can be selected so that only a small section of a gaussian diffraction-limited focus exceeds the required intensity. This “thresholding” effect is especially effective when exploiting the nearly deterministic nature of optical breakdown observed for sub-picosecond pulses thus allowing fabrication of sub micron features. Here such benefits are further extended by new concepts for focusing, pulse duration, fluence, and intensity, and the invariance of damage threshold energy density even at the nanometer scale. This is not predicted by previous work or theory, and precipitates a theoretical framework that indicates that contrary to common belief multiphoton ionization is not involved, and ultra-high-precision is made possible by a mechanism dominated by Zener-seeded impact ionization.

In view of the above and in further aspects, the present invention provides a method of laser-induced breakdown of a material which comprises, first, depositing energy within a material to extract electrons from a valence band providing unbound electrons with an electron density being higher at one or more select locations of first absorption volume as compared to one or more non-select locations of the first absorption volume; and, then, depositing added energy within the first absorption volume, preferentially at each of the select locations causing contraction of the first absorption volume to a smaller second absorption volume defined by one or more regions of the material corresponding to respectively the one or more select locations, thereby causing damage of material selectively within the second absorption volume, essentially without collateral damage to the balance of material in the first absorption volume. Preferably the added energy is optical energy deposited to a penetration depth sufficient to cause electron density of at least 10ˆ9/cmˆ3; more desirably, an electron density in a range of 10ˆ19/cmˆ3 to 10ˆ23/cmˆ3; and most preferably, an electron density of 10ˆ23/cmˆ3.

In a preferred aspect of the present invention, the initial depositing of energy defines a first absorption volume having a peripheral extent or periphery where select regions are inward of the periphery. The added energy is deposited at the selection regions. Damage occurs selectively to material within the second absorption volume corresponding to the one or more select regions. In a further feature, a single pulse of optical energy having a modulated intensity profile is used to cause the initial and subsequent damage resulting in the selectively damaged areas.

In a further feature, the present invention provides a method of producing one or more features of micrometer size or less in a material that comprises generating at least one laser pulse of femtosecond duration or less and directing the pulse to the material to cause damage in the presence of an entraining fluid that entrains debris caused by the damage. The entraining fluid is selected to entrain debris caused by laser-induced damage by having a density sufficient to cause the entrainment, movement along the surface of the material to cause the entrainment, the fluid being a moving gas, an entraining liquid, whether moving or not, or as a quiescent bath. The fluid has density sufficient to cause the entrainment or at least momentum sufficient to cause the entrainment. In a further feature, the fluid may be selected to impart the desired characteristic to the material being damage.

In still further features, the invention provides a structure that includes a monolithic substrate. The substrate has a passage, at least a portion of which has a cross-dimension of less than about 1000 micrometers (10⁻³ meter). The passage comprises a subsurface segment at a depth below the surface and a plurality of conduits or vias open to the surface. In one aspect, the monolithic substrate is a body of material, and preferably an essentially homogenous body of material.

In one aspect, the passage has U-shaped with legs of the U constituting respective conduits.

In another aspect, the substrate has a groove or a plurality of grooves with at least a portion of the grooves in communication with one or more conduits. The grooves are in any desired shape, such as elongate channels, spiral, helical pattern, serpentine pattern, and interdigitated, and combinations thereof. The grooves are surface, subsurface or a combination thereof. The broad terms “groove” and “passage” encompass any configuration of 3D feature or void formed at least in part by material removal; and preferably by laser-machining of a body surface, subsurface or both.

The groove may be in the form of a spiral having an inlet end in communication with one conduit of the passage and an outlet end in communication with another conduit of the passage. The groove may be in the form of a spiral having an inlet communicating with a first passage and an outlet communicating with a second passage.

In another alternative, the groove may be in a helical pattern having an inlet end in communication with one conduit of the passage and an outlet end in communication with another conduit of the passage. The groove may be in a helical pattern having an inlet communicating with a first passage and an outlet communicating with a second passage.

In yet another alternative, the groove may be in a serpentine pattern having an inlet end in communication with one conduit of the passage and an outlet end in communication with another conduit of the passage. The groove may be in a serpentine pattern having an inlet communicating with a first passage and an outlet communicating with a second passage.

In still further variations, the structure's first passage may include one or more conduits in communication with a first group of grooves and a second passage has one or more conduits in communication with a second group of grooves. In a further feature, a first passage is constructed and arranged to provide flow communication between the grooves of the first groove set, and to prevent flow communication between the first groove set and the second groove set. A second passage provides flow communication between the grooves of the second groove set, and prevents communication between the first groove set and the second groove set. This encompasses a jumper arrangement where a groove of the second set is located between grooves of the first set.

In still further aspects related to the subsurface segment, the subsurface segment may be in the form of a spiral pattern, a helical pattern, a serpentine pattern, interdigitated, or any combination thereof. The subsurface segment may be three-dimensional; and, preferably, three-dimensional and branched.

In further features, at least a portion of the passage and/or at least a portion of the groove has a cross-dimension of about 1000 micrometers (10⁻³ meter) or less, and a submicron (10⁻⁶ meter) or less roughness; desirably, a roughness less than about 500 nanometers (½ micron); preferably, 100 nanometers or less; and, more preferably, 50 nanometers or less roughness.

The passage preferably has a length (L) and the cross-dimensional (D) corresponding to an aspect ratio of L/D greater than 15:1; and, more preferably, greater than 20:1. The cross-dimension may be hundreds of micrometers; desirably, a few hundred micrometers; more desirably, up to 1 micron; even more desirably, submicron; or, preferably, on the order of nanometers.

A preferred method of forming a microfluidic device comprises providing a liquid phase in contact with a substrate and generating a gas phase from the liquid phase by imparting optical energy to the liquid phase during laser-machining of the substrate. Machining debris is transported away from the substrate by force of the generated gas phase.

In order to machine the subsurface feature, groove or passage, the liquid phase is in contact with an interior of the substrate being laser-machined to form an interior feature or void. The interior feature may comprise one or more channels, grooves, passages, and the like.

Preferably the subsurface feature is machined via an access laser-machined from a surface of the substrate to the interior, and debris is transported from the interior via the access.

In a further aspect, the surface of the substrate is inscribed or patterned to form a surface feature; desirably this inscribing is made by laser-machining; and, preferably, made by laser-machining in the presence of a liquid phase. The surface feature comprises channels, grooves, passages, and the like. The surface feature may be formed prior to forming the interior passage.

In a related aspect, the surface feature and the interior void are machined to be in communication.

As to the gas phase of the method, bubbles of the gas phase have a maximum dimension of less than about 1000 microns; desirably, less than about 100 microns; more desirably, less than 10 microns; and, preferably, about 1-5 microns (micrometers). Further, the bubbles of the gas phase have a collapse time of at least 1 millisecond; desirably, at least 10 milliseconds; more desirably, at least 50 milliseconds; and, preferably, about 10-50 milliseconds.

Finally, in a broad aspect, the method of forming a microfluidic device comprises providing a first fluid phase in contact with the substrate and generating a second fluid phase from the first fluid phase by imparting optical energy to the first fluid phase during laser-machining of the substrate to form one or more features. Machining debris is transported away from the substrate by force of the generated second fluid phase. In one aspect, a plurality of spaced-apart features are formed, each created essentially simultaneously by respective multiple foci. At least a portion of the feature may be at a depth below the surface of the substrate. At least a portion of the feature may be inscribed on the surface of the substrate, such as a surface groove.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows the radial position on the beam where the fluence is at threshold, and is a schematic illustration of a beam intensity profile with gaussian shape.

FIG. 2 shows the laser intensity at the focus can be selected so that only a small section of a gaussian diffraction-limited focus exceeds the required intensity. FIG. 2 also shows an illustration of how an ultrashort laser pulse can create an ablation localized to a region smaller than the light resolution limit.

FIGS. 3A and 3B show that the laser intensity varies along the propagation axis. FIG. 3A is a schematic illustration of beam profile along the longitudinal Z axis and showing precise control of damage—dimension along the Z axis. FIG. 3B is a schematic illustration of beam profile along the longitudinal Z axis and showing precise control of damage—dimension along the Z axis.

FIG. 4A is a schematic of density gradients in the single spot and multiple spot patterns, each generated by a single shaped optical pulse.

FIG. 4B is a sketch illustrating single and multiple damage spots according to the invention and as illustrated in FIG. 4A.

FIG. 5 shows an experimental set-up of nanoscale machining.

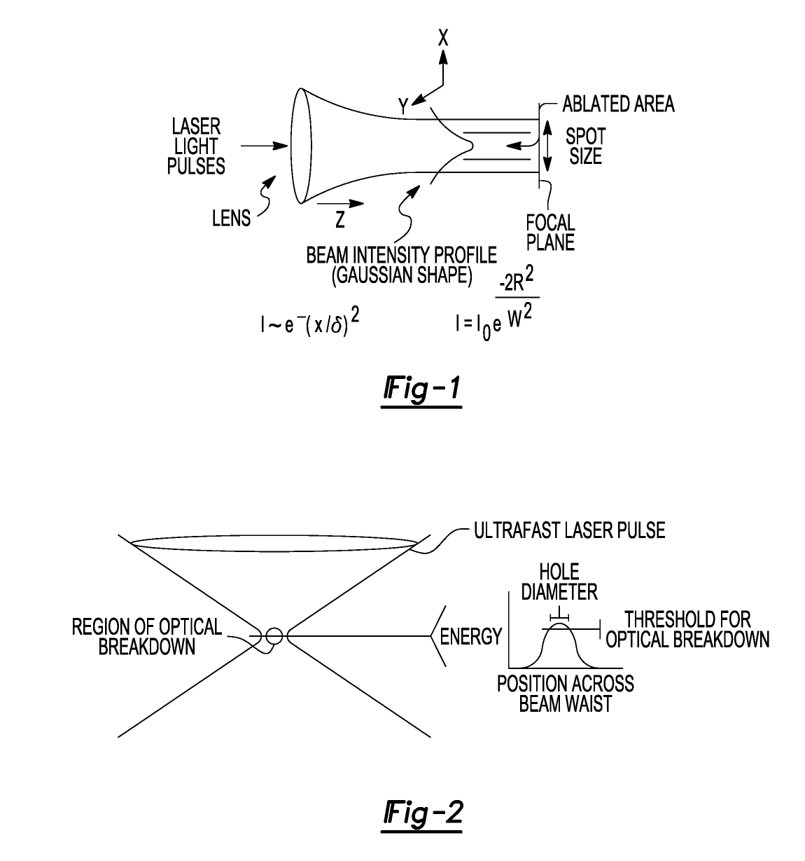

FIG. 1 shows a directly diode-pumped Nd:glass, CPA laser system (Intralase, City) which was focused through the objective of an inverted microscope.

FIG. 6A shows nanometer size holes produced with NA 1.3 and 527 nm light, where targets of Corning™-211 glass were mounted slightly inclined, and scanned perpendicular to the beam such that subsequent pulses encountered targets that were typically displaced ˜2 μm in the plane of focus, and ˜10 nm in the Z-axis. Images are features scanned by SEM. The smallest holes were generally found near the beginning of a line of features, near the point in a scan at which the target first encounters the laser focus. Subsequent panels show that holes were sometimes accompanied by surrounding features; often a raised region immediately around the holes surrounded by a circular or elliptical dip.

FIG. 6B also shows, in addition to their minute scale, at a given pulse energy the holes are essentially identical in dimension.

FIGS. 7A and 7B show that the size of the holes and the surrounding features decreases with pulse energy down to a sharp threshold below in which no changes are observed. FIG. 7A is at wavelength of 1053 nm at 1.3 NA on glass. FIG. 7B is for 1053 nm length focused on glass by a 0.65 NA objective.

FIG. 8 shows well-defined ablations in a cell membrane.

FIGS. 9A and 9B show schematic illustrations of the processes that lead up to material ablation over the interval of a laser pulse.

FIG. 10 shows surrounding features are redeposited material extruded from ablated region. (A) Scanning electron micrograph (SEM) of a row of holes in glass. Prior to viewing, the sample was blasted with pressurized gas, causing pieces of the surrounding feature to break off revealing a flat surface below (arrows). (B) SEM of an array of holes in glass produced at a glass-water interface. Note that features surrounding the holds are suppressed or absent. (C) A ˜30 nm wide channel machined in glass. A channel was produced by scanning laser scanning the sample through the laser focus with the help of a piezoelectric nanostage (Made City Labs, Inc., Madison, Wis.), so that the successive pulses hit the sample 50 nm apart.

FIG. 11 is an SEM of a 134 nanometer groove feature formed in Corning™-211 glass while immersed in water.

FIG. 12 is a schematic of a laser nanomachining configuration illustrating a system and process.

FIG. 13 contains a schematic (13A) and micrographs (13B-13E) of a nanofluidic jumper arrangement.

FIG. 14 shows low energy femtosecond laser induced bubble dynamics micrographs (14A) and characteristic data (14B-14D).

FIG. 15 is a spiral, with 15A top view and 15B sectional view.

FIG. 16 shows a mixer, with 16A showing a schematic of the mixer device, 16B showing the device in use, and 16C showing elapsed-time mixing effect.

FIGS. 17-21 show schematics of various subsurface passage segments having communication with a surface of a substrate via conduit inlet and outlet legs.

FIG. 17 shows a serpentine pattern.

FIG. 18 shows a 3D serpentine pattern on two different substrate planes.

FIG. 19 shows a 3D subsurface spiral or helical shape.

FIG. 20 shows a 3D subsurface solenoidal shape.

FIG. 21A shows a 3D branched arrangement of subsurface passage segments, wherein the conduits or vias serve as inlet or outlet, depending on the flow pattern desired. FIG. 21B shows one inlet and seven outlets, and 21C shows one outlet and seven inlets.

### DETAILED DESCRIPTION OF THE PREFERRED EMBODIMENTS

The following description of the preferred embodiment(s) is merely exemplary in nature and is in no way intended to limit the invention, its application, or uses.

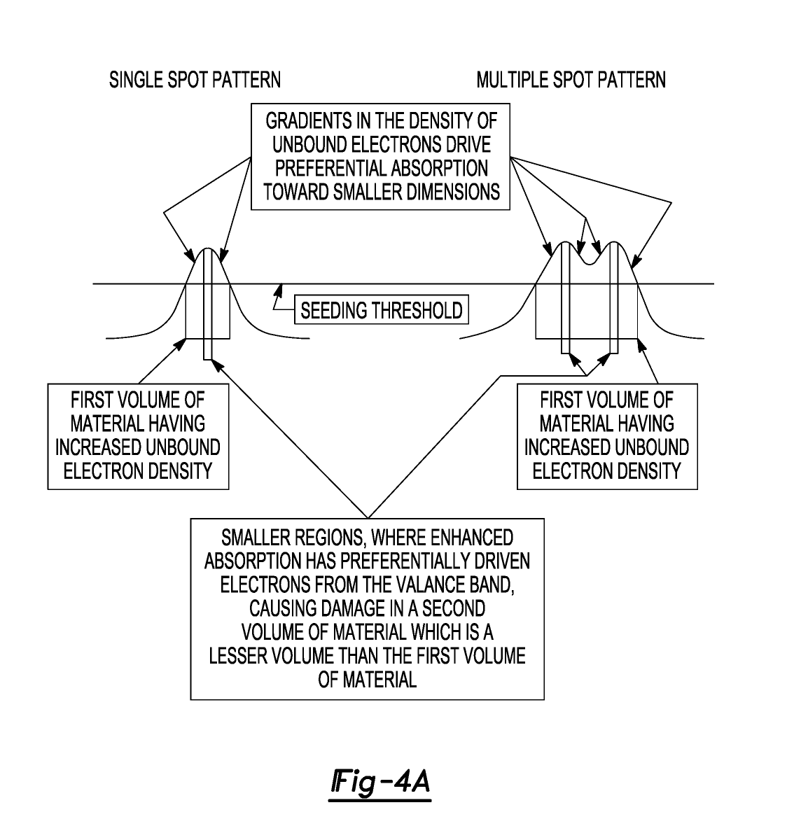

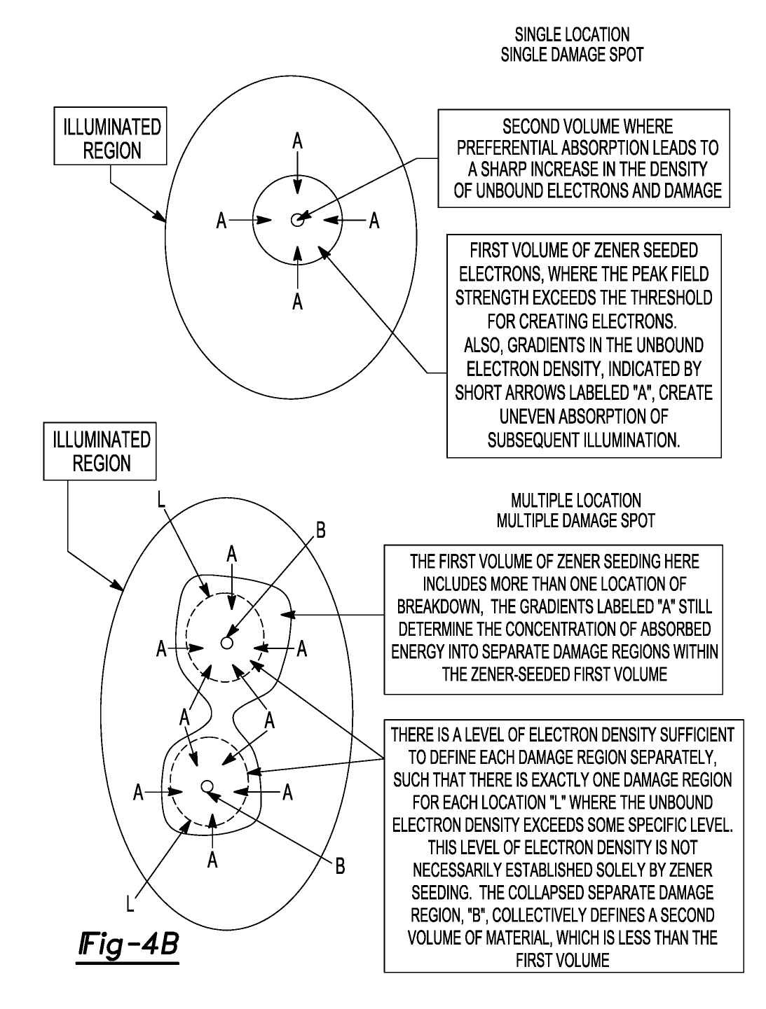

The present invention provides a method to shape an optical pulse in space and time to achieve precise deterministic effects in smaller features heretofore not previously contemplated. See FIG. 4 of the present invention showing single spot and multiple spot patterns prepared by a single optical pulse shaped in space and time providing one or more regions of increased unbound electron density. In order to foster an understanding of the present invention developments, it is useful to understand principles associated with FIGS. 1, 2 and 3. FIGS. 1, 2 and 3 are schematic illustrations of a beam intensity profile showing that for laser micro-machining with ultrafast pulse, only the peak of the beam intensity profile exceeds the threshold intensity for ablation/machining.

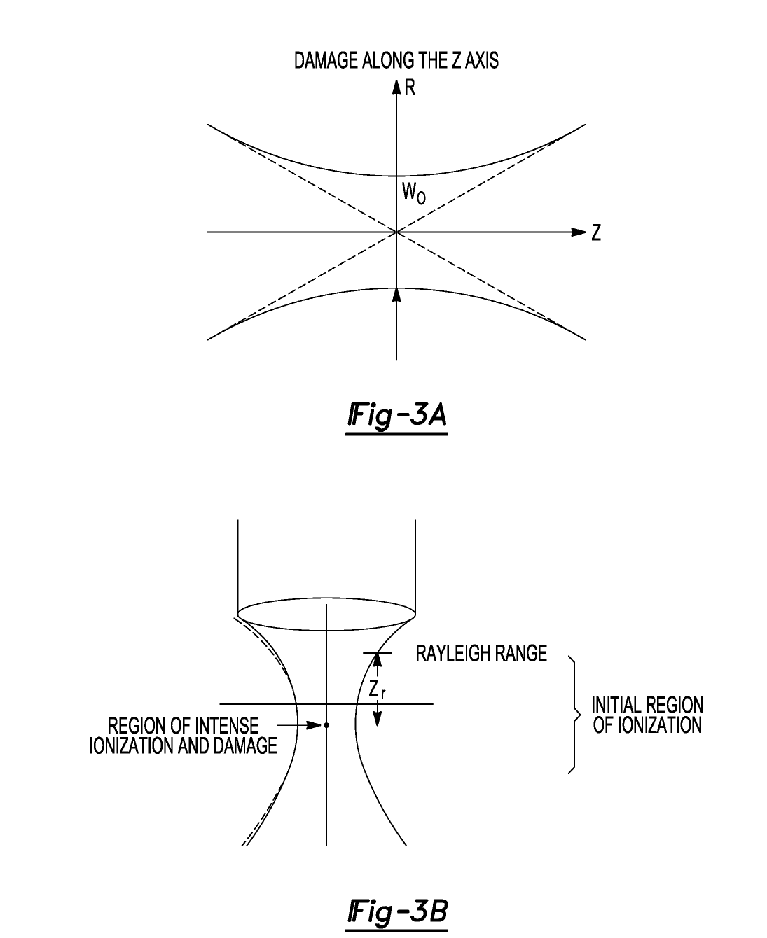

FIG. 3 shows the radial and axial position on the beam where the fluence is at threshold. Ablation, then, occurs only within a radius. It is evident that by properly choosing the incident fluence, the ablated spot or hole can in principle be smaller than the spot size. This concept is shown schematically in FIG. 2. Although the data described herein is for an exemplary 600 fs pulse, this threshold behavior is exhibited in a wide range of pulse widths. However, sub spot size ablation is not possible in the longer pulse regimes, due to the dominance of thermal diffusion as will be described below.

The present invention demonstrates that by, producing a smaller spot size which is a function of numerical aperture and wavelength, and approaching close to the threshold, even smaller features are machined. Furthermore, the axial dimension is substantially reduced to become approximately equal to radial, so material is ablated within an approximately spherical region. The ablated holes have an area or diameter less than the area or diameter of the spot size. In the special case of diffraction limited spot size, the ablated hole has a size (diameter) less than the fundamental wavelength size. The present invention has produced laser ablated holes with diameters less than the spot diameter and with diameters 5% or less of the laser beam spot size.

This increased precision at shorter pulse widths is surprising. A large increase in damage threshold accuracy is observed, consistent with the non-linear avalanche breakdown theory. It is possible to make features smaller than spot size in the X-Y focal plane and smaller than the Rayleigh range (depth of focus) in the longitudinal direction or Z axis. These elements are essential to making features smaller than spot size or Rayleigh range. The Rayleigh range (Z axis) may be adjusted by varying the beam diameter, where the focal plane is in the X-Y axis.

The present invention demonstrates unexpected high precision in a new nanoscale regime. The sharpness and reproducibility of features, and independence of polarity and target material are not fully consistent with previous non-linear avalanche breakdown theory. While not wishing to be held to any particular theory, they are compatible with new theory described herein, in which breakdown is independent of multiphoton effects, and the ablated area does not vary with bandgap fluctuations.

It has been demonstrated that sub-wavelength holes can be machined into metal surfaces using femtosecond laser pulses. Earlier results (Mourou, U.S. Pat. No. 5,656,186) could be physically understood in terms of the thermal diffusion length, over the time period of the pulse deposition, being less than the absorption depth of the incident radiation, and the further principles described hereinabove. The interpretation is further based on the hole diameter being determined by the lateral gaussian distribution of the pulse in relation to the threshold for vaporization and ablation, more specifically explained below. However, according to this explanation, it is unexpected that femtosecond machining can be extended to much higher precision, even in large bandgap nonmetallic materials as in the present invention. The present invention describes a physical mechanism by which this can be accomplished, and demonstrates feasibility.

FIGS. 3A and 3B are schematic illustrations of beam profile along the longitudinal Z axis and sharing precise control of damage—dimension along the Z axis.

It was also observed that the laser intensity also varies along the propagation axis (FIGS. 3A and 3B). The beam intensity as a function of R and Z expressed as:
I((Z,R)=I₀/(1+Z/Z_{R})²·exp(−2R²/W²_{Z})
where Z_{R} is the Rayleigh range and is equal to

$${Z}_{R} = \frac{π {W}_{0}^{2}}{λ}$$

W₀ is the beam size at the waist (Z=0).

By the present invention, it can be seen that the highest value of the field is at Z=R=0 at the center of the waist. If the threshold is precisely defined it is possible to damage the material precisely at the waist and have a damaged volume representing only a fraction of the waist in the R direction or in the Z direction. It is very important to control precisely the damage threshold or the laser intensity fluctuation.

For example, if the damage threshold or the laser fluctuations known within 10% that means that on the axis (R=0)
I(O,Z)/I₀=1/(1+(Z/Z_{R})²=0.9
damaged volume can be produced at a distance Z_{R}/3 where Z_{R} again is the Rayleigh range. For a beam waist of W₀=λ then

$${Z}_{R} = \frac{π {W}_{0}^{2}}{λ} = πλ$$

and the d distance between hole can be expressed as

$${Z}_{R} \frac{πλ}{3}$$

and as shown in FIGS. 3A and 3B.

The maximum intensity is exactly at the center of the beam waist (Z=0, R=0). For a sharp threshold it is possible to damage transparent, dielectric material in a small volume centered around the origin point (Z=0, R=0). The damage would be much smaller than the beam waist in the R direction. Small cavities, holes, or damage can have dimensions smaller than the Rayleigh range Z_{R} n the volume of the transparent, dielectric material. In another variation, the lens can be moved to increase the size of the hole or cavity in the Z dimension. In this case, the focal point is moved along the Z axis between subsequent shots to increase the longitudinal dimension of the hole or cavity. These features are important to the applications described above and to related applications such as micro machining, integrated circuit manufacture, encoding data in data storage media, and intracellular surgery.

In the present invention, the process leading to the onset of optically induced damage in material is of critical importance in determining the flow of optical energy in the process and in the determining the resulting features. It has previously been observed and described that uncertainty in the fluence associated with the threshold of damage in various materials can be greatly decreased by employing short optical pulses in the picosecond and femtosecond timescale. The present invention demonstrates that damage on a scale much smaller than the wavelength of light is practical when the damage threshold is precisely determined in this regime.

However, a new method for optical induced breakdown and new understanding of the damage process, according to the present invention, leads to unprecedented improvements in feature size and in more tightly confined collateral damage.

The process of optically induced damage may be more easily understood in the context of dielectric materials. Parallels are then drawn to delineate the distinctions and similarities between dielectrics, semiconductors and metals. The process of the present invention is applicable to all materials. Thus, the present invention is applicable to transparent, opaque, biologic, non-biologic, organic, inorganic, metal, semi-conductor, among others. Best results are achieved with solids and non-solids that are densified. More broadly with regard to fluids, the process applies to liquids as stated and fluids having relatively uniform electron density; yet gasses are problematic.

In one aspect, a short pulse of light is concentrated to a simple focus within a transparent dielectric material with sufficient total energy to cause a permanent change to the material. As the leading portion of the pulse energy passes into the focal volume, it produces sufficient field strength in the material to cause electrons that are initially bound in the valence band of the material to be promoted to the conduction band. As the threshold fluence for this effect, called the Zener effect, is crossed in the spatial and temporal advancement of the optical pulse, a thin pillar of unbound charge is liberated in the highest fluence region within the pulse focus. With more energy being added to the material by the advancement of the optical pulse, additional electrons are liberated either directly by the optical field or less directly by the impact of unbound electrons driven by the light of the optical pulse. Consequently, the density of electrons increases in the region where the light is more intense. Eventually the density of the charges becomes sufficiently high as to enable the optical properties of the material to be greatly altered.

Most significantly, the strength of absorption of energy out of the light field and into the unbound electron bath is driven up more sharply where the density of unbound electrons is higher. This causes a shortening of the absorption depth. The absorption process then collapses to a depth limited by the accessible charge volume density. Thus, while the optical field may be capable of promoting electrons out of the valence band in a considerable range of depth, the absorption process proceeds in such a way as to concentrate the catastrophic release of bound charge in a minimal volume, resulting in damage to a volume that is one or more orders of magnitude smaller than the wavelength of the light in all dimensions.

In this process, lateral confinement of the damage is driven by localization of the seed charges to small dimensions and by a highly nonlinear cascading of the subsequent damaging process. Length-wise confinement of the damage along the Z axis is driven by a collapse of the absorption depth to a dimension significantly shorter than a wavelength. For a tightly focused beam, the difference between length-wise (Z) and lateral (X, Y) confinement is blurred, and both effects contribute to confinement in all directors. Practically, most materials have a volume density of atoms not far from 10ˆ23/cmˆ3. Laser radiation interacts at near-threshold intensities with the most accessible electrons. This is typically one electron per atom as a second electron is less likely to be promoted out of the valence band than valence electrons at neighboring sites, due to electric field shielding of the first unbound electron. The presence of the unbound electrons, promoted from the valence band by the Zener effect, causes absorption, reflection and shielding of incident light. Absorption of the light is one of the stronger components in most interactions. The depth of absorption of light in a neutral collection of unbound charges is described in terms of a plasma frequency and its relation to the optical frequency. With near optical frequencies and electron masses near the rest mass of an electron (in materials electrons may have effective mass less than their rest mass), the density of unbound electrons needed to block the transmission of light is about 10ˆ19/cmˆ3. At a density near this threshold the depth over which absorption occurs may be quite long. At densities near 10ˆ23/cmˆ3 the absorption depth is about 100 nm for 1-micron wavelength light. Thus, when damage occurs, it can be driven to scales easily an order of magnitude below the optical wavelength.

In semiconductors illuminated with light significantly below their characteristic bandgap, damage follows the lines of the dielectric model just described. In such material the Zener effect is the same or the level of the Zener effect will tend to be lower. If light is incident on a semiconductor with a photon energy very near to or above the bandgap energy, the light will directly promote electrons to the conduction band via the photoelectric effect. This causes the semiconductor to behave more like a metal, and directly exhibit a short absorption depth. The nonlinear cascading effects are of equivalent dependence or of less dependence. A significant enhancement in the disruption of the material takes place in regions of higher optical fluence when a collapse in the absorption depth takes place. In short, promotion of electrons into the conduction band by the Zener effect is augmented by direct promotion by photons. The scaling of threshold with bandgap in the case of silicon suggests cascading or avalanche occurs, with the degree of significance varying.

Lateral confinement of the damage in insulators, semiconductors, and metals to dimensions much smaller than the wavelength of the illuminating light is based on the disruption of the bonding structure of valence electrons. In any of these materials ultrashort optical pulses have the capability to produce damage with extremely low uncertainty and with low pulse energy. The energy fluence damage threshold was characterized based on the only portion of the material to be damaged being that which was illuminated at a fluence exceeding that threshold, leading to a transverse damage dimension about equal to or somewhat smaller than a wavelength. Now the new method of pulse shaping leads to a collapsing of the absorption depth to the transverse dimensions, with effective absorption near a Zener-seeded region to cause sharp localized enhancement of optical absorption and subsequent damage.

The damage process of the invention occurs in two parts involves two portions of an optical pulse. Under the influence of the first portion of the pulse the material is seeded for optical damage where the light is most intense. Under the influence of the second portion of the pulse the actual damage is driven in a smaller volume by preferential absorption of the remaining light.

In its simplest form this process leads to a single damage spot with dimensions more than an order of magnitude smaller in size than the wavelength of the incident light. This is illustrated by the line crossing the spatial profile of a gaussian beam focus near its peak (see FIG. 4A, single spot pattern). FIGS. 2, 4A and 9A all show parameters as a function of position across beam waist. FIGS. 2 and 4A show fluence parameter and FIG. 9A shows fluence and other parameters. In FIG. 2, energy refers to fluence. Fluence refers to pulse energy per unit of area. That is, incident area in a direction traverse to the beam direction. Intensity refers to fluence per pulse direction. As the energy of the optical pulse arrives at the material, the field of the light produces unbound electrons where the threshold for production is exceeded. But, the mere production of unbound electrons is not sufficient to damage a material. The remaining portion of the pulse is preferentially absorbed in a decreasing volume, delivering the greatest concentration of absorbed energy in a collapsed volume of material: a volume approaching or limited by the penetration depth of optical radiation in a density of 10ˆ23/cmˆ3 of electrons.

A more complex pattern of illumination is used to obtain a specific pattern of damage (see FIG. 4A, multiple spot pattern). In this case, a single pulse is passed through an optical system to create a specific intensity pattern. The portions of the pattern that are most intense are capable of establishing regions where the density of unbound electrons is higher (step 1) and also of driving those regions into damage (step 2). It is the gradient in the density of unbound electrons that causes the subsequent reduction in the size of the damaged volume. Thus, it is necessary for the intensity modulation available in step 1 to instill a sufficient gradient in the density of unbound electrons to drive the subsequent concentration of absorbed energy to a smaller region.

In any damage event, the threshold for damage is defined by a loss of structure in the bonds formed by valence electrons. The present method provides optically damaged spots very significantly smaller than a wavelength. The spots may be formed in isolation, or in specific patterns. The damages spots are produced sequentially or simultaneously.

Note that because the energy damage threshold of the materials is deterministic, and the definition of the damage region is self sharpening, it is not necessary to obtain full optical resolution according to the conventional definitions. Modulation profiles with reduced visibility may be used to define multiple-damage profiles or patterns. Such profiles themselves may be generated with peak-to-peak spacing well below a wavelength.

In FIG. 4B, there is a single spot illustration showing three circles. The outer circle is the illuminated region; the middle circle is the first volume having Zener seeding; and the inner most circle is the damage volume, which is a second volume of material less than the first volume of material.

In FIG. 4B, there is also a multiple spot example. The outer circle shows the illuminated region; the FIG. 8 shape defines the first volume of Zener seeding; the gradients associated with the first volume are labeled “A”; separate locations or centers, “L,” are illustrated by dashed circles; and the collapsed separate damage regions, “B,” collectively define a second volume, which is less than the first volume.

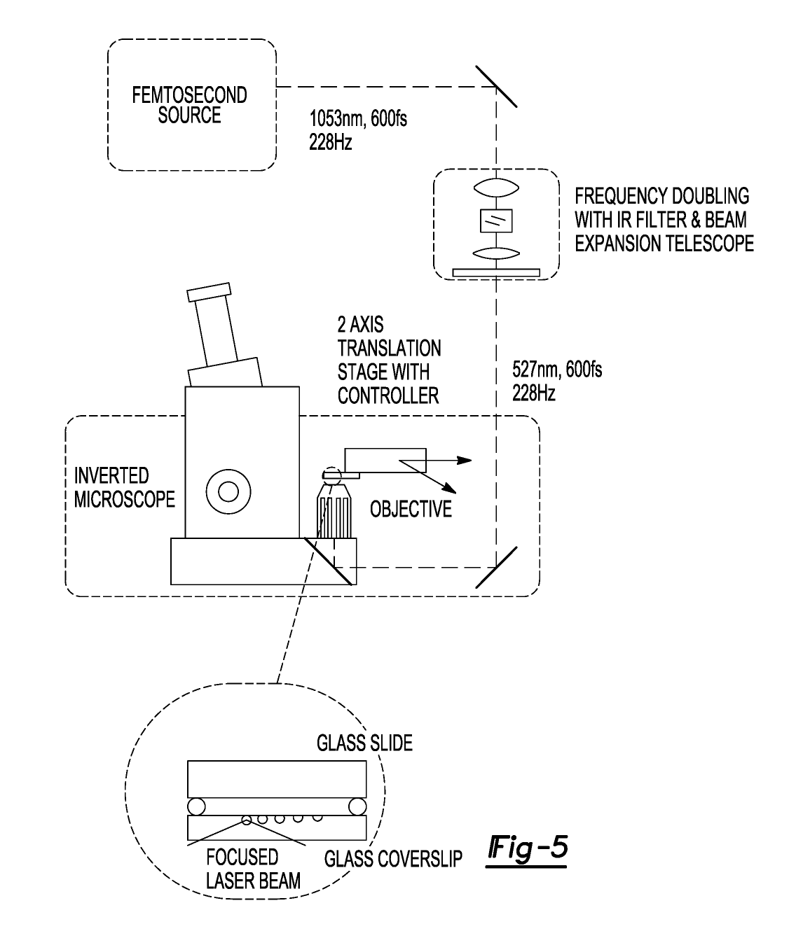

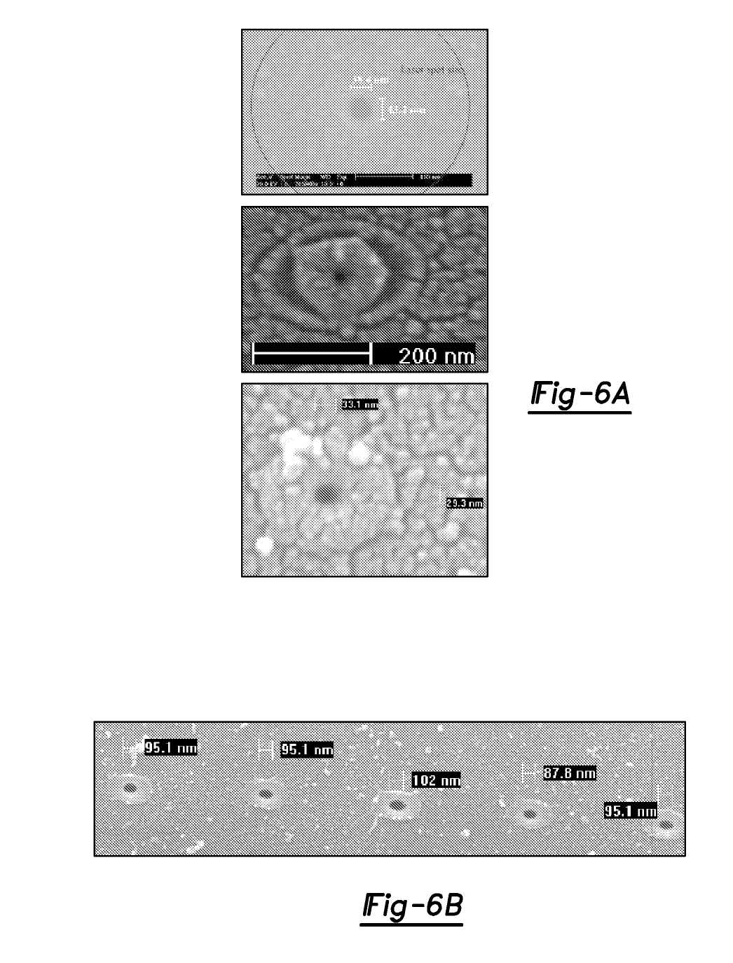

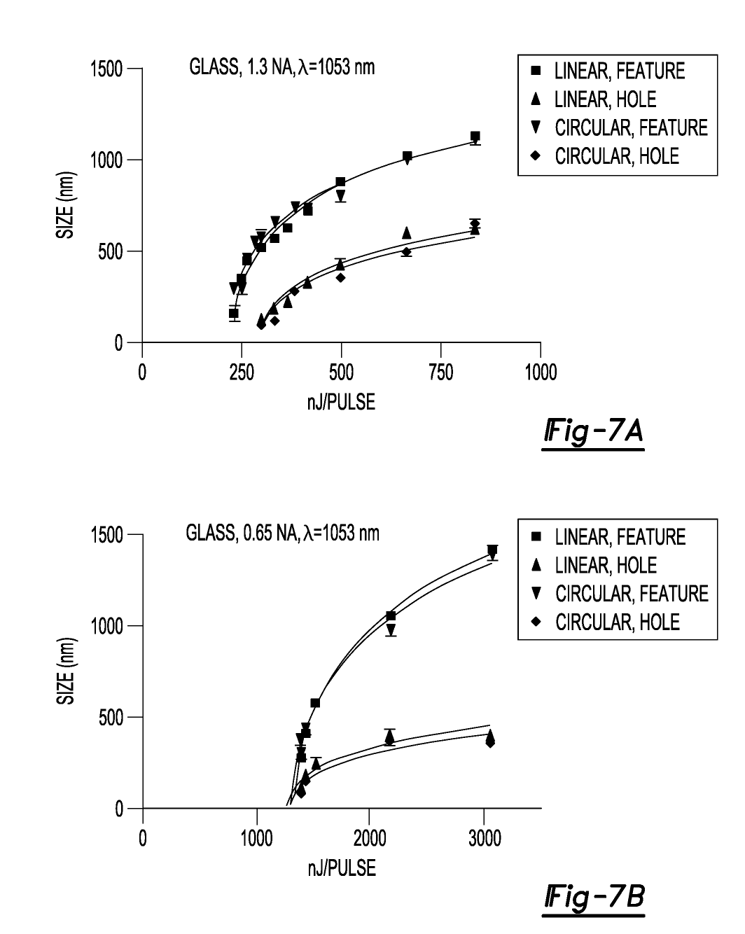

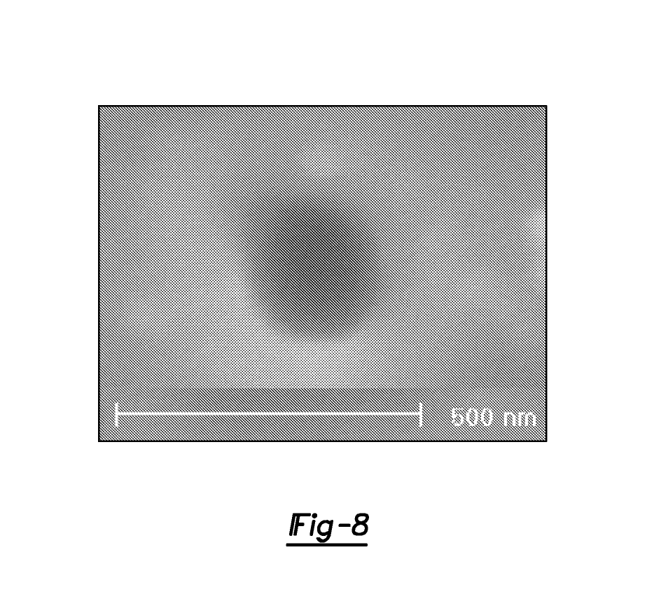

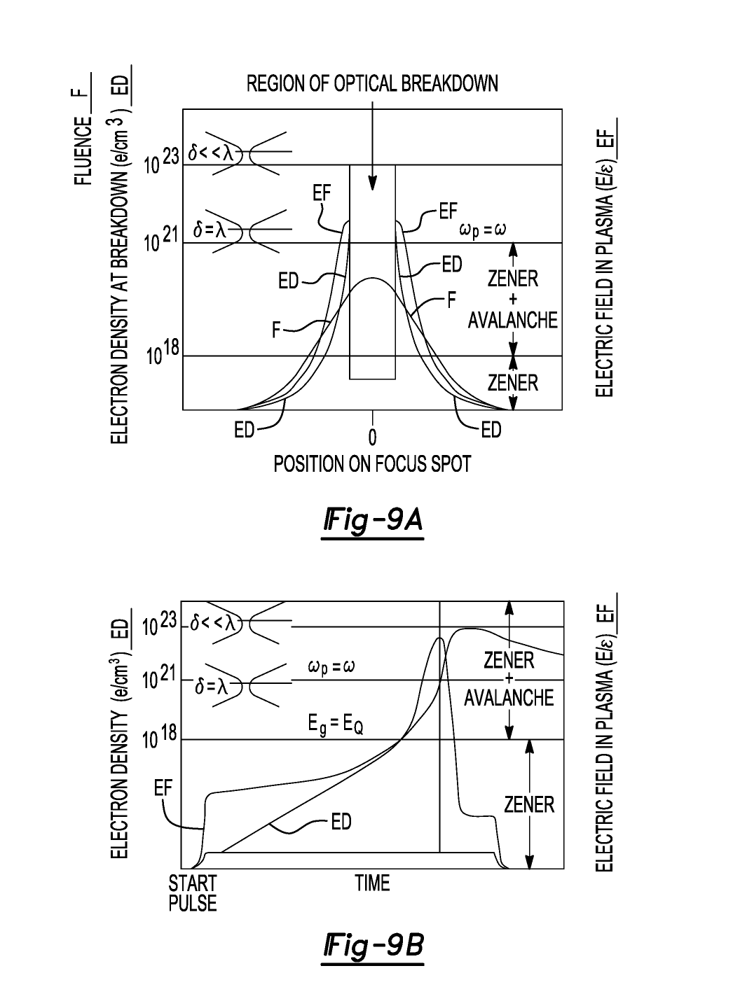

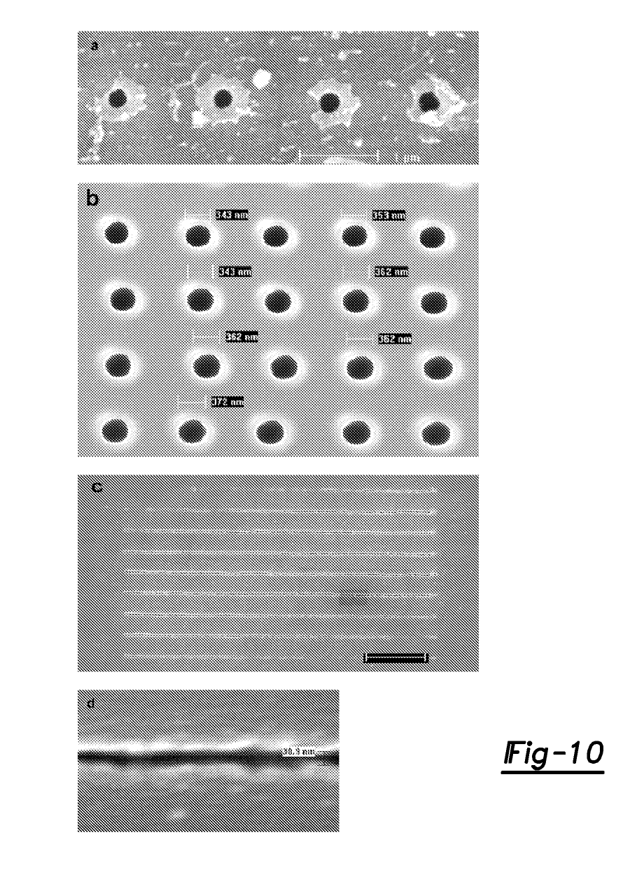

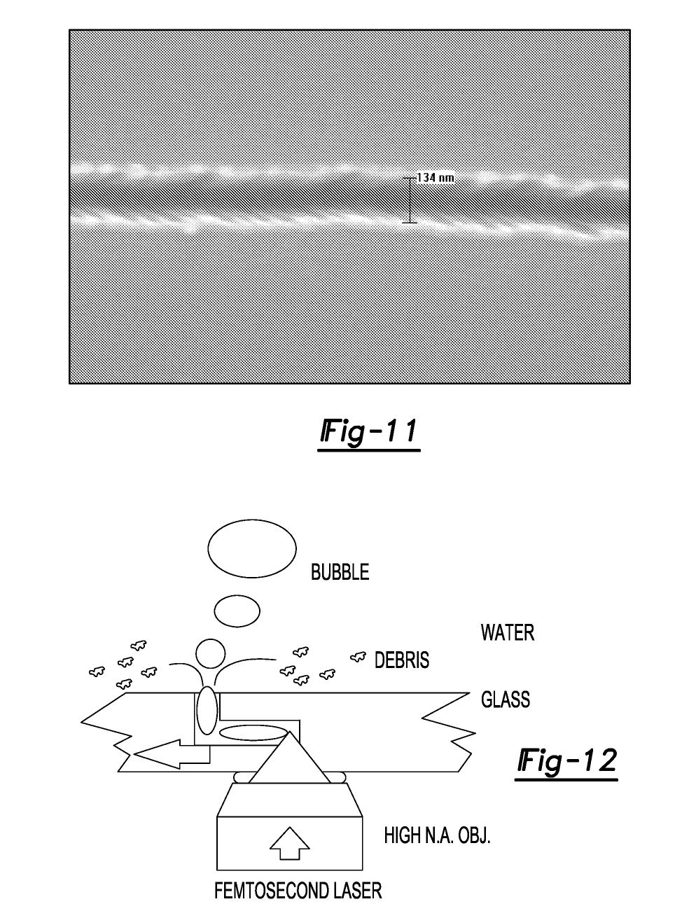

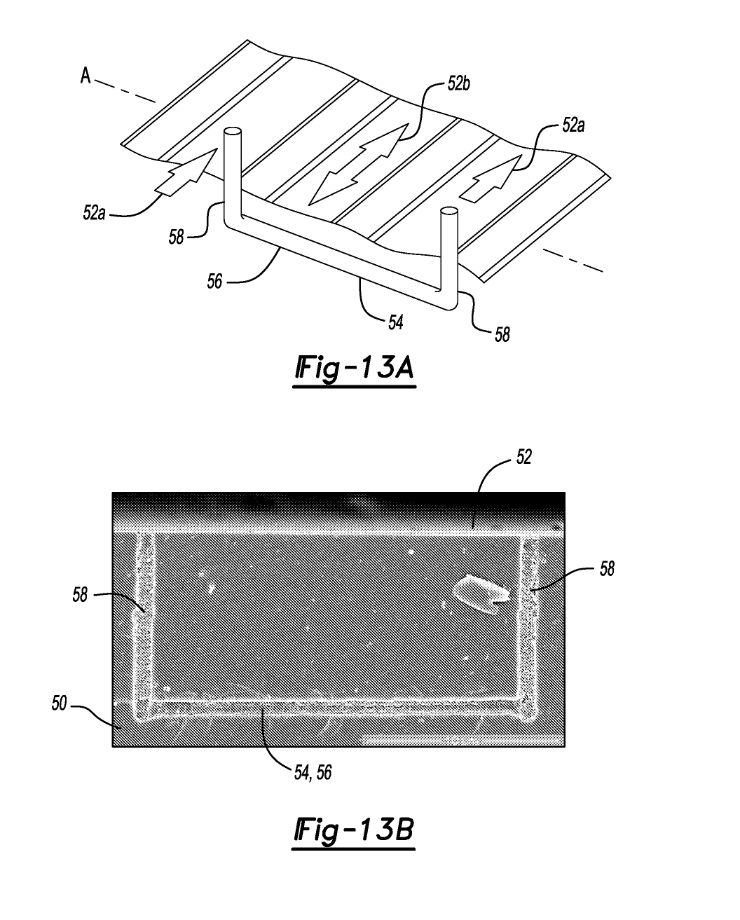

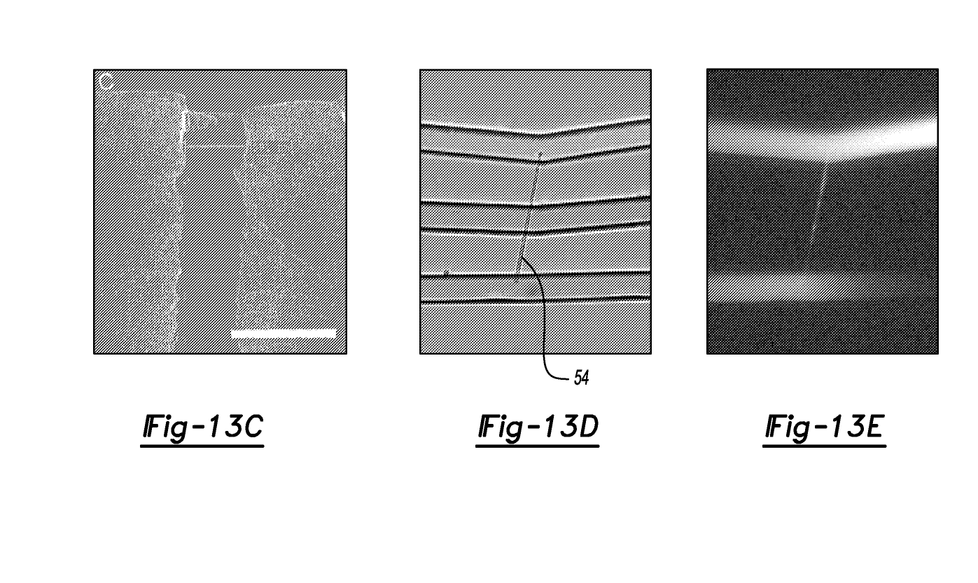

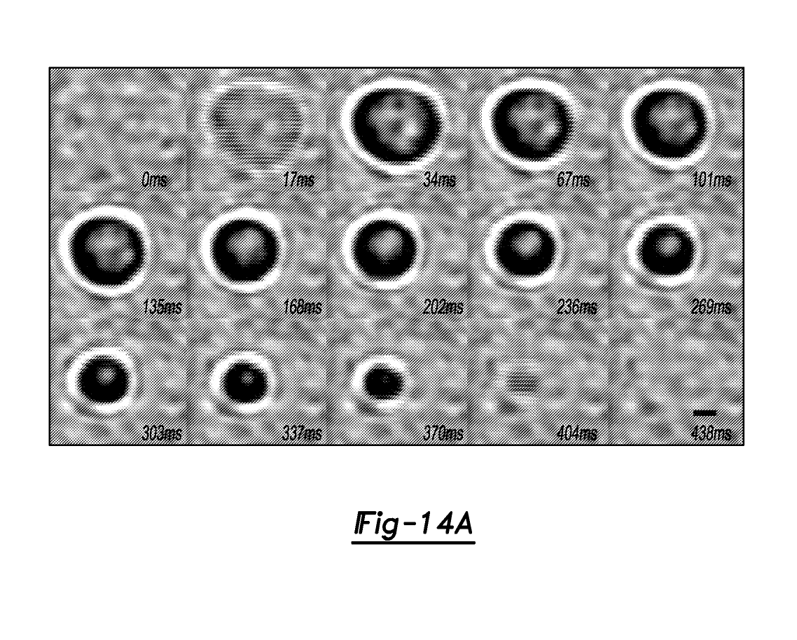

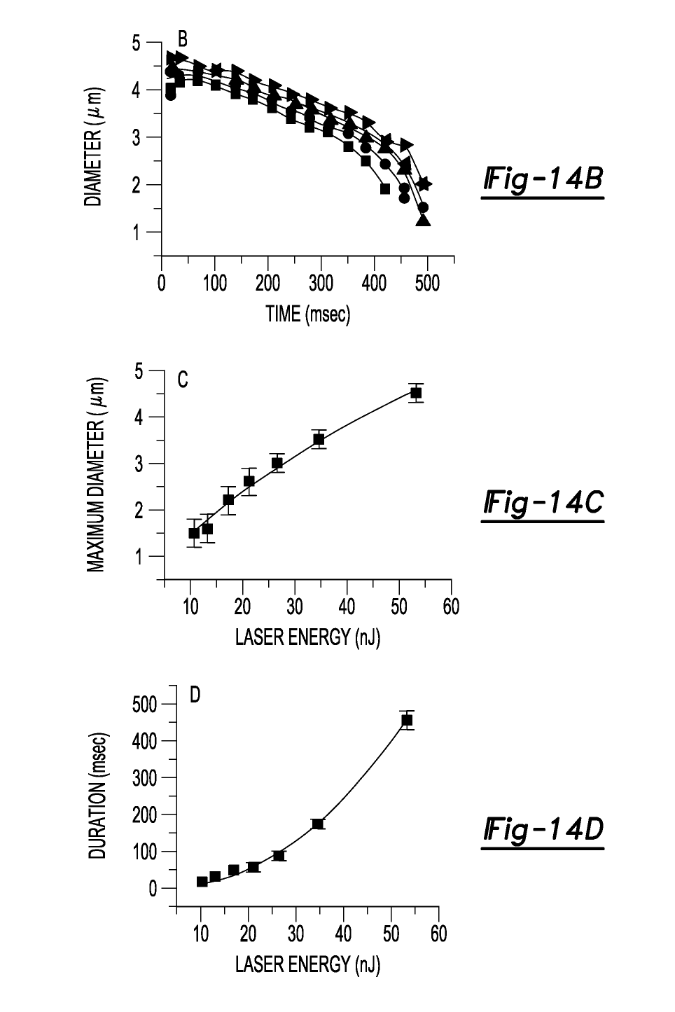

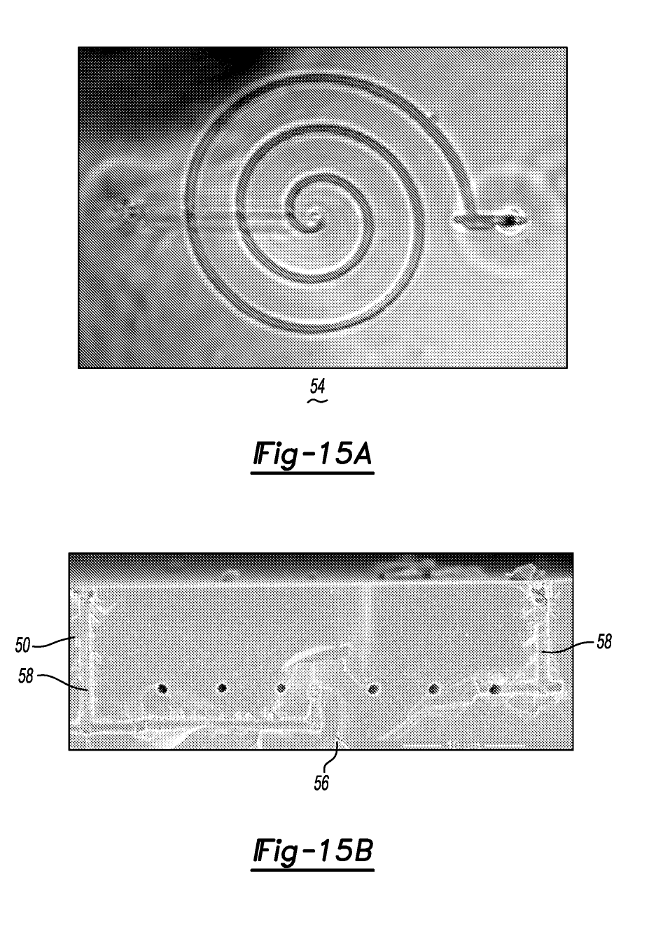

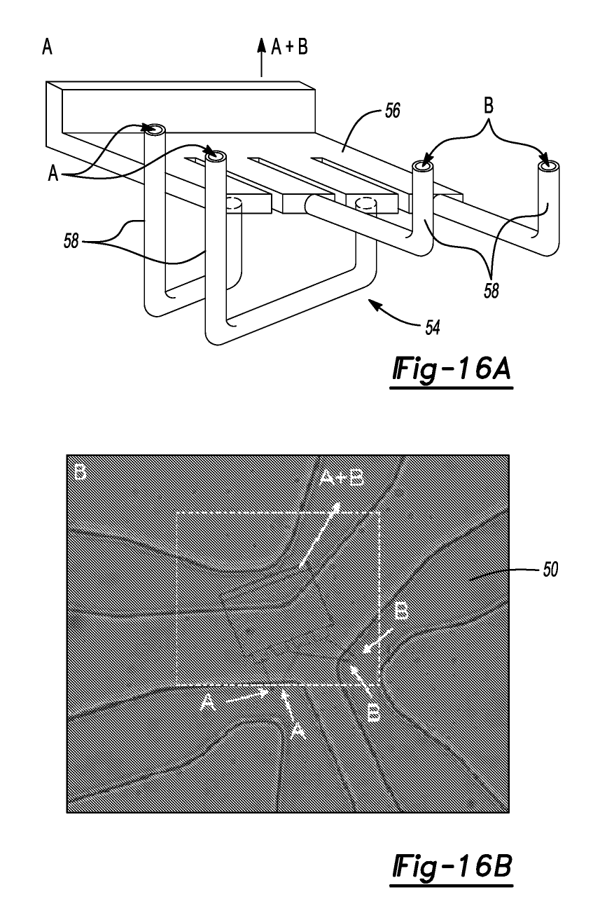

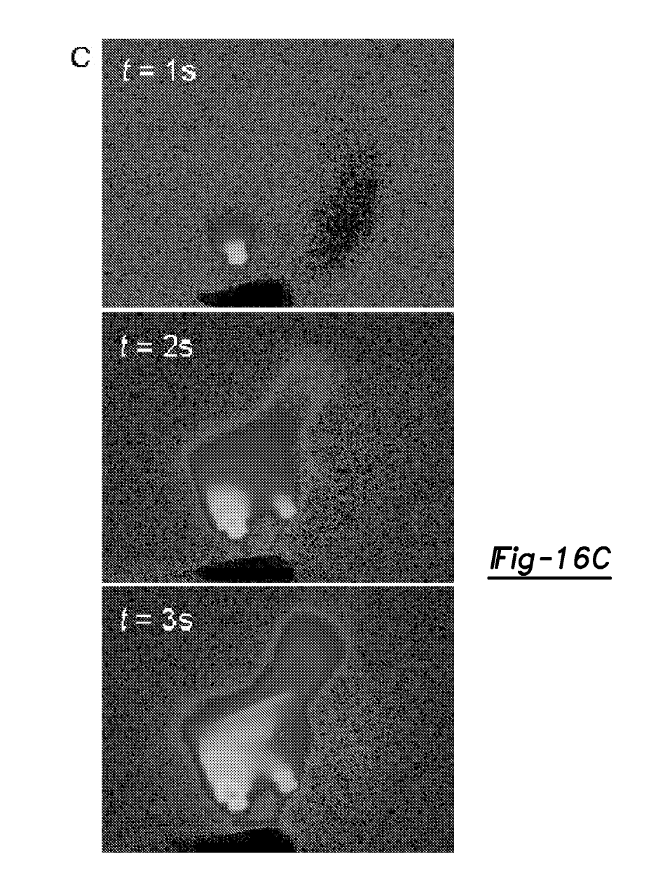

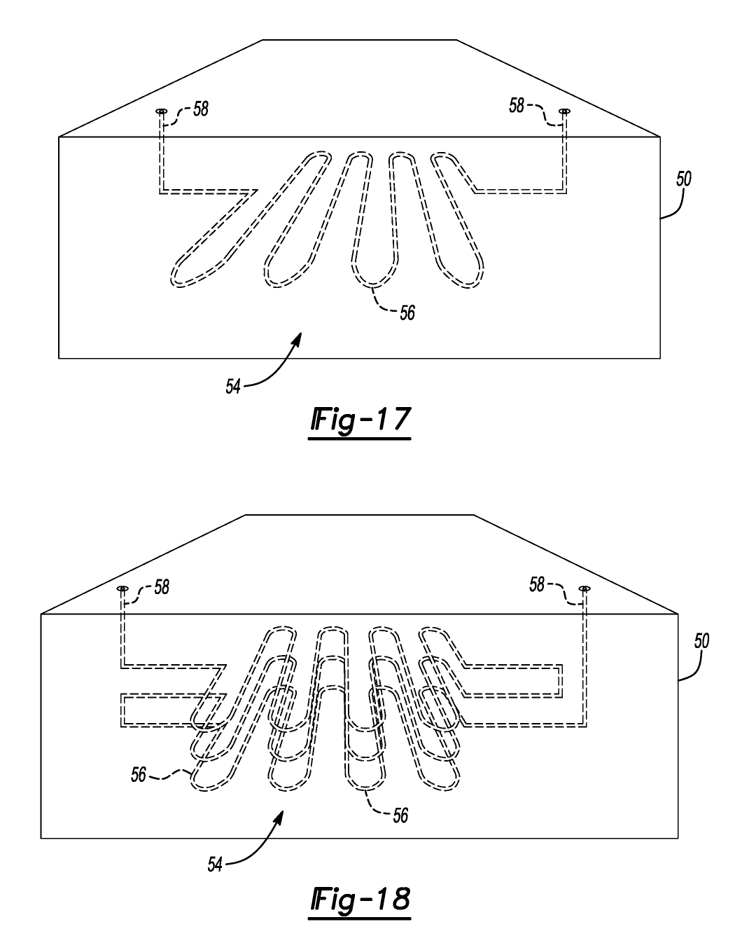

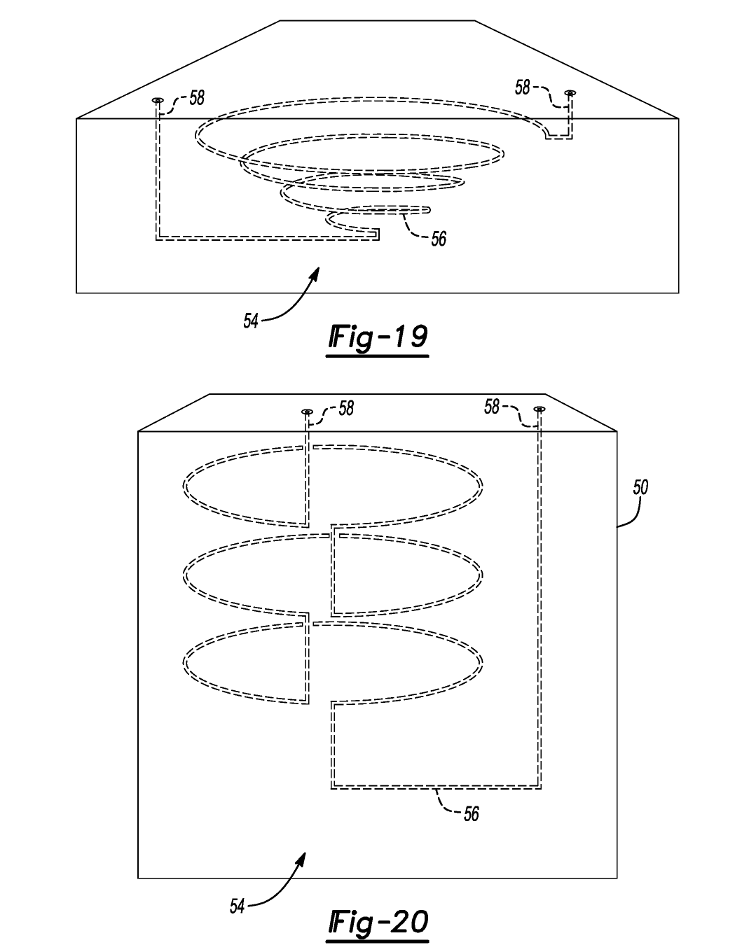

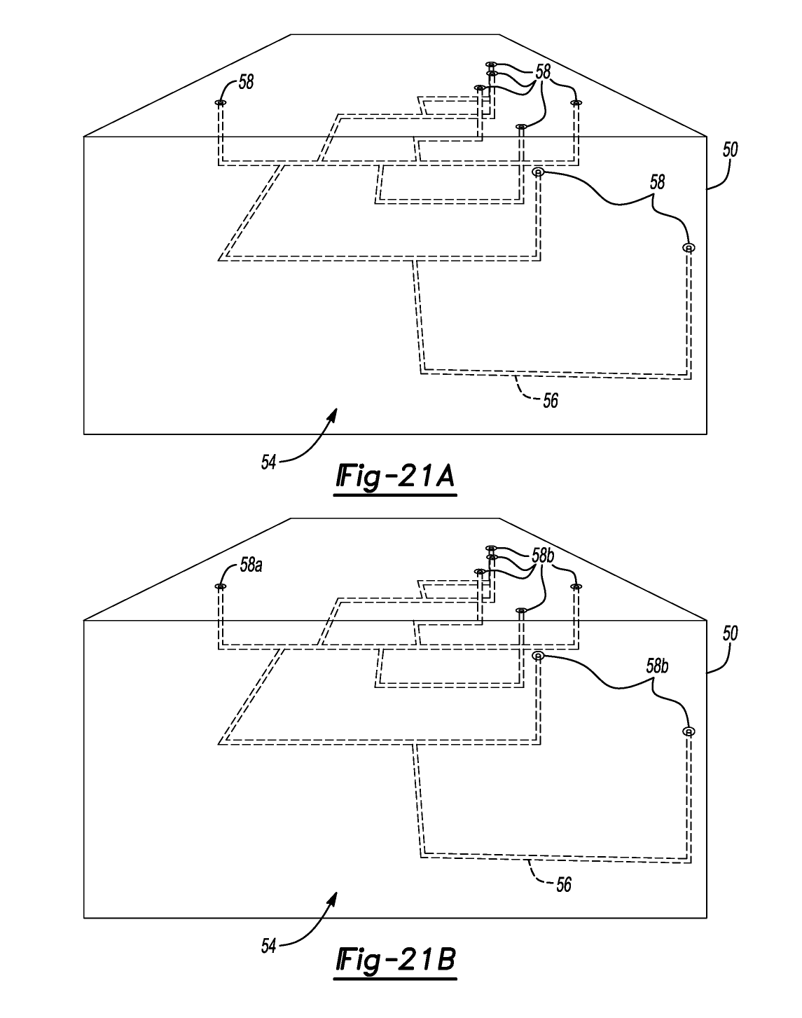

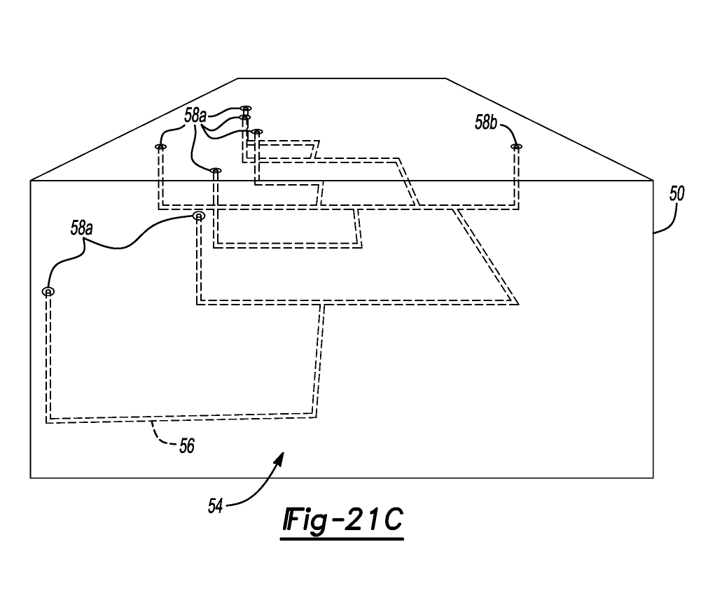

FIG. 5 shows experimental set-up of nanoscale machining. These experiments were performed with a directly diode-pumped Nd:glass, CPA laser system (Intralase Inc.) operating at 1053 nm, with 30 mW average power at a repetition rate of 1.5 kHz and a pulse width of 600 fs. The laser beam (at 1053 nm or frequency doubled with a KTP, type I crystal (Cleveland Crystals) was expanded to overfill the back aperture of the objective. It was then brought into the epifluorescence path of an inverted microscope (Axioverte 225, Carl Zeiss inc.) and focused by one of the two objectives: Zeiss Neofluar 1.3 NA, 100X objective or 0.65 NA, 40X (Carl Zeiss Inc.). Five materials, in the form of cover slips, were used: Corning Glass 0211, Single Crystal Quartz (Ted Pella), Fused Silica, Sapphire, or Silicon. The surface of a cover slip was cleaned with an air-duster prior to machining. The cover slip was then mounted on a glass slide with double-sided tape. The slide was secured to a computer-controlled, two axis motorized stage, or a three axis nanopositioning stage, fastened to the microscope stage. The surface of the cover slip being machined was imaged to obtain visual feedback while machining. With the 1.3 NA, oil immersion objective, the laser beam was focused on the surface distal to objective to avoid the oil-glass/quartz interface. With the 0.65 NA, air objective, machining was carried out on the surface immediately facing the objective. The repetition rate of the laser and the speed of the stage were adjusted to get a reasonable separation between adjoining features. The average power of the beam was measured prior to the dichroic mirror used to reflect the beam into the back aperture of the objective, and was varied at the source or with a reflective variable density filter.

FIG. 6A shows some examples of nanometer-scale holes.

FIG. 6B shows scanning electron micrograph (SEM) of a row of holes in glass. Samples were coated after laser machining with either gold or Palladium to a thickness of ˜10-20 nm in a sputter-coater. SEM analysis was done on a Philips XL30 FEG microscope. Size measurements were carried out manually with an in-built function in the microscope control software In operation a directly diode-pumped Nd:glass, CPA laser system operating at 1053 nm, with a repetition rate of 1.5 kHz and a pulse width of (600) fs was focused through the objective of an inverted microscope (FIG. 5), as described above. The smallest holes were created by frequency doubling and expanding the beam to fill the back aperture of a 1.3 numerical aperture oil-immersion objective, which formed a focus on the far side of the target, i.e., glass or quartz coverslips.

In some cases, targets were mounted slightly inclined, and scanned perpendicular to the beam such that subsequent pulses encountered targets that were typically displaced ˜2 μm in the plane of focus, and ˜10 nm in the Z-axis (FIG. 6A). The displacement in the Z-axis from end to end of a row of holes was about the same as the largest hole diameters, indicating that they were created when a roughly spherical region at the laser focus encountered the surface of the target (data not shown). The smallest holes, e.g., FIG. 6A, were generally found near the beginning of a line of features, near the point in a scan at which the target first encounters the laser focus. By reducing the pulse energy to ˜4.5 nJ, slightly above the threshold (˜4 nJ in Corning 211 glass) below which features vanish, the present invention consistently machined circular holes as small as 20 nm, and in some cases as small as 18 nm or 15 nm. Even at these minute scales, the features have sharply delineated edges, suggesting that even smaller holes could be achieved using shorter wavelengths, and/or approaching even closer to threshold. Holes were sometimes accompanied by surrounding features; often a raised region immediately around the holes surrounded by a circular or elliptical dip, e.g., FIG. 6A, panels 2 & 3.

In addition to their minute scale, the holes are also striking in their reproducibility (FIG. 6B); even when the smallest holes are produced with a pulse energy within 10% of threshold, every pulse creates an identically sized hole (with measurement error of about 10% for 20 nm). That is, the size varies by only about 10%, generally less than 5%, preferably less than 4% and as low as 3½% or less. This amazing consistency indicates that the initial charge carriers that seed avalanche ionization must be created in a very reproducible manner. Such carriers have been theorized to be either pre-existing, or arise from multiphoton ionization or tunneling of electrons through the atomic field potential barrier which is suppressed by the strong electric field of the intense light (Zener ionization). Pre-existing carriers cannot explain our results; producing holes of such small scale and sharp (<5 nm) edges with regularity and precision would require 10¹⁸ e/cm³ free electron densities, far higher than present in large bandgap materials.

To discriminate between the later possibilities we compared optical breakdown by linearly and circularly polarized pulses in three materials with bandgaps ranging from 1 eV for silicon and 10 eV for sapphire. When using tightly-focusing high NA objectives these comparisons are difficult due to difficulty assuring that the Z-axis position of laser focus is the same. For example, the data shown in FIG. 7A was taken by measuring the hole and feature diameters near the center of scanned rows at different pulse energies. The threshold appears different for the holes and the surrounding features, suggesting that the laser focus was somewhat below the surface; at low energy the region of optical breakdown becomes small enough that it no longer penetrates the surface, only the surrounding features are visible. When experiments were performed using an air objective with a longer depth of focus (NA=0.65), the threshold is revealed to be the same for the holes and the surrounding features (FIG. 7B). Assuming that the size reflects thresholding of the gaussian intensity profile of the focused spot (see FIGS. 7A and 7B we fit the feature and hole size data

$$D = σ \sqrt{8 ln ( \frac{E}{γ} )} ,$$

where D is the diameter, E is pulse energy, γ and σ are fitted parameters: γ gives the threshold energy. The same threshold was indicated by fits to the features and the holes.

More particularly, FIGS. 7A and 7B show that the size of both holes and the surrounding features decreases with pulse energy down to a sharp threshold below which no changes are observed. Data is fit to: diameter

$$diameter = σ \sqrt{8 ln ( \frac{E}{γ} )} ,$$

the expected relation given the gaussian intensity profile of the focused spot. The 1053 nm pulses focused on glass by a 0.65 NA objective. The pulse energy arriving at the sample is substantially less since the objective is not optimized for near-infrared. The 527 nm pulses focused on glass by a 1.3 NA objective. For comparison the measurements were made near the center of each row of features created at different pulse energies. This excluded the smallest holes, which were found near the ends of each row.

In other words, the diameter of both holes and the surrounding features decreases with pulse energy down to a sharp threshold below which no changes are observed. In FIGS. 7A and 7B, results for linearly and circularly polarized light are shown. Data is fit with diameter

$$diameter = σ \sqrt{8 ln ( \frac{E}{γ} )} ,$$

where E is pulse energy, γ and σ are fitted parameters. In FIG. 7A, 1053 nm pulses focused on glass by a 1.3 NA objective. The pulse energy arriving at the sample is substantially less since the objective is not optimized for near-infrared. FIG. 7B 1053 nm pulses focused on glass by a 0.65 NA objective.

FIG. 8 shows an SEM of a hole in a cell membrane. CHO cells were cultured on coverslips and fixed with gluteraldehyde before laser ablation by 1053 nm pulses focused through a 1.3 NA objective. Tests were also conducted on silicon, quartz, sapphire, and fused silica with similar favorable results, even smaller holes could be produced by using shorter wavelength light.

As duration of a pulse is very short, free charge carriers must be produced rapidly and reproducibly. In quartz and silicon, which have well-defined bandgaps, reproducibility is less surprising. But the bandgap structure of glass is more variable, yet this is not reflected in the structure of features produced by optical breakdown. Without being held to any particular theory, it appears that within the region of optical breakdown the number of carriers produced is sufficiently large as to always exceed the minimum required to seed complete ionization through Zener and avalanche mechanisms.

Measured by AFM, the depth of holes in glass produced by near threshold fluence at an approximately 2 micrometers (nm) focus spot size was ˜50 nm. As light absorption occurs over the depth of highly ionized material, this represents the upper bound of the plasma skin depth. This is on the order of the predicted ˜30 nm skin depth if all 10²³ cm⁻³ valence electrons are ionized, indicating complete ionization in the region of the holes.

By the present invention, a methodology for high-precision laser machining features of unprecedented small (nanometer) size has been developed. The present invention's approach takes advantage of the highly non-linear dependence of optical breakdown on intensity, coupled with extremely tight focusing by high numerical aperture objective, to create features that are over an order of magnitude smaller than the wavelength of light. By adjusting the laser power, it can reproducibly create holes as small as or smaller than 20 nm with little variation from one hole to the next (<5%). Because little power is required (each pulse is ˜4-10 nJ) it is a simple matter to form more complicated structures by repeatedly machining holes at different locations; for example, by the present invention pipes and channels have been machined many microns long by repeatedly firing pulses at a glass target while displacing its X, Y, and Z-axis position (see FIG. 11). For more rapid processing, the focus of multiple beams could be simultaneously scanned in three dimensions. The technique is versatile; it does not require specific target materials and is relatively easy to execute, and for many applications it is simpler, more reliable, and more versatile compared with other methods capable of producing features on this size scale, e.g., e-beam lithography and nanoimprinting.

This enabling technology has potentially broad applications for MEMS construction and design, microelectronics, optical wave-guides, microfluidics, materials science, microsurgery, optical memory, and creating structures to interface with cells and biological molecules. It can also extend the utility of ultrafast lasers in biology. We have applied ultra-high-precision laser machining to produce well-defined ablations in cells (FIG. 8), and anticipate that it will have great impact in the biological sciences, including research in cell motility, development, growth-cone and neurite extension, and targeted disruption of genetic material.

To assure that the scale of features was not affected by small variations in the Z-axis position of the laser focus, comparisons between materials were made using the low NA objective. Reproducible features were created in quartz, silicon, fused silica, sapphire, and Corning 0211 glass using 1053 or 527 nm light. At 527 nm the threshold energy for quartz and glass was 10 times greater than silicon; at 1053 nm the threshold for quartz was ˜25% less than glass, and about 5 fold greater than silicon (Table I). The threshold intensities and thus the electron quiver energy approximately scale with the band-gap, suggesting that breakdown is indeed an avalanche process. In all cases the threshold was independent of the polarization. Since circularly polarized light is extremely inefficient for producing multiphoton processes, these results largely exclude multiphoton ionization as a source of initial charge carriers. Thus avalanche ionization is principally seeded by electron tunneling.

Given that electron tunneling seeds avalanche ionization, and without wishing to be held to any particular theory, the following is thought to apply. The deterministic nature is especially surprising in glass, where the variability of the band-gap structure is not reflected in the structure of features produced by optical breakdown. This can be explained if observable damage occurs only when the quiver energy is significantly beyond the critical ionization energy: damage depends on transition from strongly under critical free electrons density (i.e. zero) to supercritical. The carriers are first created in a confocal volume at or near the surface by single photon absorption or tunneling and not in a significant way by multiphoton excitation. When the carrier quiver energy given by

$${E}_{OSC} = 〈 \frac{{e}^{2} {E}^{2}}{2 m {ω}^{2}} 〉 or {E}_{osc} = {9.310}^{- 14} I {λ}^{2}$$

becomes greater than the band-gap the carriers are further multiplied by impact ionization. The time between collisions τ decreases as the electron energy increases to become of the order of 100 attoseconds for eV energy. The increase in free electron density sharply augments the plasma frequency ωₚ, and will decrease the dielectric constant to near zero when the plasma frequency reaches the laser frequency.

$$ɛ = 1 - {( \frac{{ω}_{p}}{ω} )}^{2} with {ω}_{p}^{2} = \frac{4 π n {e}^{2}}{m}$$

The electric field in the plasma is equal to E/∈^{0.25}. So, when the plasma frequency becomes close to the laser frequency ω, the electric field experiences a strong enhancement, further increasing impact ionization, and producing a run away process that will stop when all the valence electrons are ionized. When the plasma frequency becomes greater than the laser frequency (ωₚ>ω) the electric field in the plasma drops, and the plasma becomes strongly absorbing. The light won't propagate and will be absorbed over the skin depth δ given by

$$\frac{c}{{ω}_{p}} < δ < \frac{c}{{{ω}_{p} ( 2 ω τ )}^{1 / 2}}$$

For 10²³ e/cm³ this skin depth or penetration depth is of the order of 30 nm. The impact depth of 50 nm that we measured is an upper bound of the skin depth. The depth of features indicates that damage occurs when the ionized electron density is approximately equal to the density of atoms; that is, one valence electron is ionized from every atom valence electrons are ionized. FIGS. 9A and 9B schematically illustrate the time course of these events.

The finding that damage is governed by the valence electron density reveals the feasibility of UHPLM; it can work with any material even if the bandgap is ill-defined or variable. Since 10 n 23 e/Cmn³ electrons are ionized in the region of material damage, the smallest achievable scale will ultimately be limited by the skin depth and/or the diffusion of ionized electrons out of the region of breakdown. The latter limit can be estimated at ˜10 nm, and since it depends on the pulse length, even smaller features are attainable using shorter pulses.

Thus the physics of UHPLM are extremely well-suited for a broad range of applications requiring discrete high-precision material modification, such as MEMS construction and design, ultra high density microelectronics, nanofluidics, materials science, optical memory, creation of structures to interface with cells and biological molecules, and targeted disruption of intracellular structures, and for many applications it is simpler and more reliable compared with other methods capable of producing nanometer features (e.g., electron-beam lithography and nanoimprinting).

FIG. 9A is a schematic illustration of the processes that lead up to material ablation within the focus of a laser pulse. The electron density is indicated on the left axis, and by the line ED. The F line indicates the profile of fluence across the gaussian focus spot. The electric field in the region of ionization (plasma) at the onset of material damage (breakdown) is indicated by the EF line. The fluence F and the electric field lines EF indicate relative changes; actual values are not given. The insets graphically illustrate the decreasing skin depth (δ) that the laser penetrates (skin depth) as the free electron density increases (the shaded areas indicate free electrons in the dielectric). The skin depth becomes approximately equal to the incident wavelength (λ) at 10²¹ e/cm³, as illustrated in the lower inset. The plasma frequency ωₚ increases with the free electron density. As ωₚ approaches the laser frequency the electric field experiences a strong enhancement and all valence electrons are rapidly ionized. This transition causes the material to become heavily absorbing over a skin depth that is much smaller than the wavelength (λ), as indicated in the upper inset, and it is quickly vaporized.

FIG. 9B is a schematic illustration of the processes that lead up to material ablation over the interval of a laser pulse. The shaded region at the bottom indicates the duration of the laser pulse. The electron density ED is indicated on the left axis, and by the ED line. The changing electric field in the region of ionization (plasma) is indicated by the EF line. When the field is such that the electron quiver energy is below the bandgap (E_{Q}<E_{g}), free electrons are produced only by Zener ionization. When the electron density passes ˜10¹⁸/cm³, the quiver energy exceeds the bandgap, and avalanche ionization begins. This process takes place over the skin depth (δ) that decreases as the electron density increases, becoming approximately equal to the incident wavelength (λ) at 10²¹ e/cm³, as illustrated in the lower inset. As the plasma frequency ωₚ approaches the laser frequency the electric field experiences a strong enhancement and all valence electrons are rapidly ionized. This transition causes the material to become heavily absorbing over a skin depth that is much smaller than the wavelength (λ), as indicated in the upper inset, and it is quickly vaporized.

TABLE I
Optical Breakdown Thresholds Using Linear
and Circularly Polarized Light

| Material | λ (nm) | Linear (nJ) | Circular (nJ) |
|---|---|---|---|
| Corning 211 | 527 | 59 ± 3 | 62 ± 3 |
| | 1053 | 1271 ± 75 | 1305 ± 84 |
| Quartz | 527 | 62 ± 2 | 56 ± 4 |
| | 1053 | 950 ± 57 | 933 ± 88 |
| Silicon | 527 | 5.8 ± 1.1 | 6.1 ± 1.1 |
| | 1053 | 172 ± 24 | 194 ± 20 |
| Sapphire | 527 | 68 ± 3 | 75 ± 5 |
| | 1053 | 1774 ± 34 | n.d. |
| Fused Silica | 527 | 49 ± 2 | 57 ± 4 |
| | 1053 | 907 ± 189 | 1063 ± 29 |

In another aspect, the invention provides a method to create nanoscale features with reduced or essentially no collateral damage. This aspect is best understood in contrast to present methods. Typically, an ultrafast laser beam is focused onto a target substrate, and the substrate surface is scanned through it to machine features in the desired pattern. This process is complicated by the deposition of the debris formed during the process of optical breakdown in the region surrounding the features; that is, deposits surrounding the holes such as in FIG. 10A. This is a two-fold complicating effect: (1) the resulting features are harder to control; and (2) the surrounding area is left with debris, which might be undesirable.

The process of the invention avoids this problem of deposition. Micromachining was carried out at a substrate target surface in the presence of an entraining fluid, such as immersed in water, so that redeposition of debris is prevented. The entraining fluid, water, helped to quench the ionized debris and carry it away (FIG. 10B). FIG. 10C shows an ˜30 nm wide channel machined in glass, and FIG. 10D shows a detailed section of the SEM of FIG. 10C.

This process leads to sharp and clearly defined features without altering the surrounding material. For these reasons, this technique is a tremendous improvement in almost all micro fabrication processes using femtosecond lasers. The process can be varied for large scale micromachining by maintaining a flow at the interface or selecting fluids, liquids and gases appropriate to the manufacturing process. Depending on the substrate being micromachined, a variety of fluids are used which serve the dual purpose of imparting a desired treatment to the surface, while serving to keep it clean of debris generated during micromachining.

The technique provides great improvement to laser micromachining used in MEMS, microelectronics, micro/nanofluidics, fabricating optical memory, and for ultra high density microelectronics or optical memory fabrication, since it leaves the adjacent substrate surface unmarred and usable for further processing. It assists nano-fluidics fabrication by serving to keep the machined channels open by carrying away the debris as it is generated.

FIG. 11 shows an SEM of a 134 nm groove manufactured in water. The channel is essentially a clean and adjacent surface free of debris.

Advantageously, the invention identifies the regime where breakdown threshold fluence, and the ablation dimensions do not follow the local bandgap variations, and makes use of such regime to provide greater precision and reproducibility of laser induced breakdown, and to induce breakdown in a preselected pattern in a material or on a material. The invention makes it possible to apply laser machining in a regime where nanometer-scale features are consistent in size, sharp-edges, and reproducibility.

The application of the invention to micro- and nanofluidics is particularly advantageous as further described below.

Micro- and nanofluidic technologies have long sought a fast, reliable method to overcome the limitations of planar fabrication, lithographic size limits, and sub-optimal materials. These limitations are overcome by direct 3D machining of sub-micron diameter fluidic channels in glass, via optical breakdown near critical intensity using a femtosecond pulsed laser. The presence of liquid is critical to keep the channels free of debris during the machining process; microbubbles expanding by an unusual non-cavitation mechanism induce laminar flow, which gently extrudes fluid entrained debris from the channels. Rapid prototyping of nanofluidic devices containing 3D “jumpers”, mixers, and other useful components are demonstrated here.

Complex microfluidic devices are of broad interest for basic research and have far-reaching applications including diagnostics, chemical analysis, sensors, drug discovery and microreactors. Efforts to produce highly complex microfluidic devices capable of generalized chemical processing are challenged by space limitations and the inability of fluidic channels to cross paths without mixing. Yet most microfabrication methods are inherently planar and are not capable of submicron dimensions, and to date the most complicated devices have relied on multilayer soft lithography using polydimethylsiloxane (PDMS) and similar materials. While these devices have intriguing possibilities, the limitations of PDMS (lack of solvent resistance, leaching, protein adsorption, inability to contain high pressures) prevent adaptation to a variety of desirable analytical applications. The invention provides microfluidic processing architecture, both 2D and 3D; microfluidic features, including passages, channels, grooves, and the like; and embedded or at least partially embedded grooves, embedded or at least partially embedded passages, embedded or at least partially embedded channels, embedded or at least partially embedded chambers, and the like. It should be noted that the invention is not limited to any particular architecture or geometry of feature and is exemplified by arrays of columns; posts; undulated and sawtooth passages, grooves and cavities; and variable cross-section passage, grooves and cavities.

The rapid prototype of 3D submicron-diameter channels, exemplified in glass here, not only allows for rapid art-to-part production of micro-/nanofluidic devices, but the simple fact that the material is glass offers numerous advantages over the state of the art in rapid prototyping of microfluidics. Glass is the standard for a wide variety of analytical applications due to its relative inertness, ability to withstand high pressures and organic solvents, hydrophilicity, low adsorption, and a long history of well-characterized surface derivatization chemistries. However, the features of the invention are not limited to glass and apply to any material. High pressure liquid chromatography (HPLC), patch clamping, microsequencing, and other integrated microscale analysis systems especially benefit from the present fabrication method.

During machining, material is removed by inducing optical breakdown with a focused femtosecond pulsed laser. The machining is direct without subsequent steps, in contrast with other methods in which channels are produced by HF post-etching material initially damaged with a femtosecond laser. The present invention directly creates arbitrary sub-micron patterns and channels using ultrafast lasers, and creates nanometer-scale shallow patterns. This invention provides the ability to drill extremely long, deep channels in a substrate when nanomachining is performed under a fluid such as water. The channels are completely free of debris, in contrast to extensive visible debris in 4-7 μm diameter channels produced with a less-tightly focused laser. This is possible because microbubbles produced at the site of optical breakdown gently propel fluid-entrained debris away from the machining site, rather than causing collateral damage from shock waves or violent collapse commonly associated with laser-induced cavitation bubbles.

Optical breakdown induced by femtosecond laser pulses is extraordinarily precise when the energy is near threshold; that is at “critical intensity”. The precision of “optics at critical intensity” (OCI) enables reproducible laser machining of sub-diffraction limit features on surfaces and precision down to the nanoscale has recently been demonstrated above by producing features on the order of 10 nm on the surface of a wide variety of materials. This competes with the resolution of e-beam lithography, but is more straightforward and less material-specific. Here, OCI nanomachining comprises a novel approach to arbitrary 3D nanomachining, extended to directly produce subsurface features, thereby enabling free-form 3D nanofabrication. Here, submicron diameter channels, hundreds of microns in length, are directly fabricated. By scanning a glass target through the laser focus (FIG. 12), complex 3D structures were easily produced that are uniform and free of debris. Especially remarkable is the production of channels of extremely small diameter (<700 nm) and relatively long length (>200 μm), yet free of debris and capable of passing fluids (FIG. 13).

FIG. 12 is a schematic of laser nanomachining system. Femtosecond pulses are focused through a high numerical aperture oil-immersion objective onto the target substrate. The substrate is immersed in water and scanned through the laser focus with a nanopositioning stage. Water bubbles formed as a part of the machining process carry debris out of the channel.

Details of the machining set up are as follows. Machining was performed using 600 fs pulses, 10-18.5 nJ/pulse, frequency doubles to 527 nm and produced by a directly diode-pumped Nd:glass, CPA laser system (Intralase Corp., Irvine, Calif.) with a repetition rate of 1.5 kHz. The target substrate 50 (typically a glass coverslip) is placed on a 3-axis microscope nanomanipulation stage (Mad City Labs, Inc., Madison, Wis.). Water or other fluids are brought into contact with side of the substrate distal to the microscope objective (NA=1.3), and the laser is focused to a spot at the substrate-fluid interface, which is located when a single laser pulse simultaneously forms a hole in the substrate and a bubble in the fluid. The nanostage moves the substrate in a preprogrammed pattern to create the different parts of nanofluidic channel. To machine the wells or grooves 52, the stage moves the substrate 2 nm per step, 1200 steps per second, scanning successively deeper into the substrate until the desired depth is achieved. Horizontal grooves 52 in the form of channels are produced by moving the sample, in 100 nm steps, 10 μm forward, and then 7 μm backward for a net forward movement of 3 μm; this is repeated until the desired length is achieved. Typically a single pass using this procedure is sufficient to form an open channel, but greater uniformity can be achieved with multiple passes.

FIG. 13 is a nanofluidic jumper referred to as a passage 54 having a segment 56 and vias or conduit legs 58. The legs 58 join the passage 54 to the grooves 52. The problem of joining two streams in grooves 52A separated by a middle stream in groove 52B without mixing is solved by machining a nanoscopic U-shaped channel passage 54 traversing underneath the middle stream in groove 52B. (A) Schematic of the nanojumper 54. (B) SEM of a cross-section of the jumper 54. Cross-section view was achieved by breaking the glass along the plane of the jumper after “scoring” the top surface with the laser and manually snapping the part in two. Scale bar=10 μm. (C) Close up of another channel machined using smaller steps between pulses to produce a smoother surface. Scale bar=1 μm. (D) Transmitted light microscopy image of the jumper. Nanojumper length is 117 μm. (E) Fluorescence microscopy image of the jumper showing fluid flow between the two outermost channel grooves 52A without contaminating the middle stream in groove 52B. Fluid flow is produced by electroosmosis using a potential of several volts. This illustrates subsurface passage 54 having legs 58 in flow communication with grooves 52 on the surface of substrate 50. However, an alternative embodiment is also contemplated where the passage has conduit legs in flow communication with subsurface grooves and conduit legs open to the surface as inlet and outlet.

Previous attempts at microscale machining have resulted in channels that are filled with debris. The problem in air is overcome here and direct machining of open nanochannels was accomplished with the glass target immersed in water. Since this depends on expulsion of debris from the nanochannels, the dynamics of expanding bubbles formed during the machining process is critical. Classically optical breakdown produces cavitation bubbles that collapse violently, and if near a solid surface produce spalling or debris pulverization by shock waves and reentrant jets. Such cavitation bubbles might have maximum diameters dₘₐₓ ˜1 mm and collapse in times T 2-300 μs, resulting in supersonic speeds at the bubble wall during the final moments of collapse. In contrast, video of bubbles created by the present tightly focused, low-energy femtosecond pulses in water, away from surfaces, show bubbles that are 3 orders of magnitude smaller (diameter dₘₐₓ=1-5 μm) and that last for 1-2 orders of magnitude longer, (collapse time T ˜10-50 ms (FIG. 14)). Thus the characteristic collapse speeds (˜1 mm/s) are far below the liquid sound speed and spalling is reduced or eliminated as a major contributor to the machining action.

FIG. 14 shows low energy femtosecond laser induced bubble dynamics. Bubbles created by tightly focused, femtosecond laser near critical intensity being smaller and longer in duration differ significantly from classical cavitation bubbles. The expected collapse speed is far below sonic, thus collateral damage from bubble is eliminated. (A) Frame-by-frame morphology of a bubble created with a single laser pulse of 53.3 nJ. Scale bar=1 μm. (B) Diameter versus time for 10 different bubbles, each generated with single laser pulse of 53.3 nJ. (C) Maximum bubble diameter versus laser energy. (D) Bubble duration versus laser energy. Rayleigh bubble scaling implies d⁵ₘₐₓ/T² ˜(16π/ρ) E. Least-squares power-law fits to the data in (C) and (D) show dₘₐₓ ˜E^{0.70} and T ˜E^{1.9}, respectively, thus d⁵ₘₐₓ/T² ˜E^{0.91}.

While not wishing to be held to any particular theory, here it is analyzed whether these small, slow-growing bubbles follow classical theory for bubble behavior. Classical theory for bubble expansion and collapse assume that viscosity and heat transfer are unimportant. Rayleigh's expression for bubble lifetime T ˜(3ρ/8ΔP)^{1/2} dₘₐₓ; combining this with the mechanical energy of the bubble E=ΔPπd³ₘₐₓ/6, (here ΔP is the pressure inside the bubble at its maximum diameter dₘₐₓ) and eliminating ΔP gives a scaling d⁵ₘₐₓ/T² ˜(16/πρ) E, where ρ is the density of water. On the basis of the small bubble Reynolds numbers in our experiment (Re ˜10⁻²), one might be tempted to assume that viscosity renders this scaling invalid. However, if the bubble is far from walls, it should create a purely radial flow, and inspection of the Navier-Stokes equations and continuity in spherical coordinates shows that viscous terms are identically zero in this case; therefore, Rayleigh scaling should still apply, and indeed we observe (FIG. 14) power-law exponents consistent with this prediction: dₘₐₓ ˜E^{0.70} and T ˜E^{1.9}, therefore d⁵ₘₐₓ/T²˜E^{0.91}.

In further considerations, deviation of the exponent from unity may be attributed to the proximity of the walls during the experiments, which were performed in a chamber ˜2.5 μm deep to keep the bubbles in the focal plane. However, taking the constants of proportionality into consideration, the data also show that the apparent mechanical energy of the bubble is at least 12 orders of magnitude less than the absorbed energy; that is, on the order of about 10% of pulse energy. This is probably in large part due to the dominance of viscous dissipation and heat loss for these very low Reynolds and Peclet number (Pe ˜10⁻⁴) bubbles in addition to energy required for phase change. Comparative experiments use lasers with on the order of greater than 10 mJ. The present invention uses on the order of about 18 nJ. Thus, comparative experiments use six orders of magnitude more pulse energy than in our experiments, resulting in relatively high Reynolds number bubbles (Re=10²−10⁶). In short, it seems likely that (a) bubble growth and collapse do not directly modify the glass substrate through jet formation, and (b) the bubble mechanical energy is largely diffused away by thermal conduction.

It is noted that the entire lifetime of a bubble is O (100 ms)—long enough to allow bubbles to be further inflated by subsequent shots at the 2 kHz repetition rate used for machining. The resulting bubbles can be large enough that they are extruded from the mouth of a channel if it is less than a few hundred microns from the site of optical breakdown. Using multiple passes, sweeping the laser back and forth across the region to be machined away, allows fluid to refill into the cavity once these large bubbles have been initially created.

Conventional experimental studies have been conducted using lasers with six orders of magnitude more pulse energy (>10 mJ) than in the present invention's experiments (˜18 nJ), resulting in relatively high Reynolds number bubbles (Re=10²−10⁶). Since the Prandtl number Pr is near unity, RePr is also large, so only a small fraction of the energy is diffused away as heat. In our experiments, RePr ˜10⁻⁴, so a large fraction of the absorbed energy is diffused away. This is a simplified view of diffusion processes during expansion, which are likely to be quite complicated near the gas-liquid and solid-liquid surfaces, but the result is qualitatively consistent with the observation of extremely low apparent energy for mechanical expansion. In short, it seems likely that (a) bubble growth and collapse do not directly modify the glass substrate through jet formation, and (b) the bubble mechanical energy is largely diffused away by thermal conduction, resulting in a much gentler action that nonetheless has the same power-law behavior predicted by Rayleigh's inviscid theory.

Applying OCI nanomachining, three major challenges in microfluidics are addressed. First, in contrast with planar photolithographic techniques, 3D capability enables construction of out-of-plane jumpers, allowing fluids to cross paths without mixing (FIG. 13). Second, a frequent design challenge for micro total-analysis systems (μTAS) is the limited ability to produce long channels in a small space for chromatographic separations, hydrodynamic resistance, or to allow mixing. The spiral channel illustrated in FIG. 15 addresses this need by compacting a 143 μm channel into an area just 30 μm across.

FIG. 15 shows a substrate 50 with a spiral pattern. A passage 54 having a subsurface segment 56 in the form of a spiral channel demonstrates the ability to produce long channels in a small space for separation, hydrodynamic flow resistance, or to allow mixing. Conduit segments 58 provide respective inlet and outlet leg portions of passage 54, providing flow through the subsurface spiral segment 56. (A) Transmitted light microscopy image of the spiral. The spiral was machined at 18 nJ/pulse to produce a channel diameter of 900 nm and length of 143 μm. (B) SEM cross-section of the spiral showing it is free of debris. Scale bar=10 μm.

This also demonstrates the utility of OCI nanomachining for rapid prototyping that could drastically speed development of μTAS, while enabling designs that are much smaller and more complex. Third, mixing fluids at the micro and nanoscale is often difficult since it depends on relatively slow diffusion across laminar flows at low Reynolds numbers. FIG. 16 illustrates a simple mixer where two different fluids are divided into four small channels that crisscross so that the two fluids are interdigitated at the outflow of the small channels. By increasing fluid-fluid interface, and decreasing the width of each stream, mixing is substantially accelerated since mixing time drops with the second power of the number of interdigitated streams for a constant width channel.

FIG. 16(A) shows a schematic of a mixer as it would appear imbedded in a substrate 50 of FIG. 16(B). (A) Concept: Fluids A and B are interleaved to enhance mixing rates, but interleaving requires a 3D channel network. (B) Transmitted light microscope image of device. The three chevron-shaped channels are microfluidic channels (cast in polydimethylsiloxane (PDMS), placed atop a glass cover slip) that serve as reservoirs. Passage 54 comprises conduits 58 and cavity segment 56. Fluids are drawn through laser-machined nanochannel conduits 58 and mixed in the wide, flat, rectangular cavity, which forms a part of the subsurface segment 56 of the passage 54. The cavity is also laser-machined. A 10V potential is applied to the chip reservoirs creating the flows (arrows) via electroosmotic flow. (C) Proof of Concept: A time series of images (chip is powered at t=0) showing mixing of fluorescent Fluid A with undyed Fluid B. Visualization is performed using 0.04 mg/mL Rh-110 (zwitterionic) placed into Fluid A. Dye appears first at the leftmost finger of the cavity because this is the shortest path from the reservoir. Dye then appears at the third finger, and can be seen diffusing into undyed Fluid B. We note that normally, epifluorescent imaging of passive dyes overestimates mixing due to line-of-sight integration of signal; in the present case this is expected to be minimal due to the shallowness of the cavity (height=500 nm, width about 65 μm).

FIGS. 17-21 show schematics of various passages 54 having subsurface segments 56 in communication with a surface of a substrate 50 via conduit inlet and outlet legs 58. FIG. 17 shows a serpentine pattern. FIG. 18 shows a 3D serpentine pattern on two different substrate planes. FIG. 19 shows a 3D subsurface spiral or helical shape. FIG. 20 shows a 3D subsurface solenoidal shape. FIG. 21 shows a 3D branched arrangement of subsurface passage segments. In FIG. 21, the eight surface vias or conduits serve as inlet or outlet, depending on the flow pattern desired. One alternative is one inlet 58A and seven outlets 58B for separation function. Another alternative is one outlet 58B and seven inlets 58A for mixing function. Any combination of inlet and outlet vias may be used.

These results demonstrate the efficacy of OCI nanomachining for creating, submicron channels in arbitrary 3D patterns in transparent dielectric materials. The method is used to machine any solid 3D objects such as cones, spheres, and cantilevers. OCI nanomachining of analytical devices in glass with femtoliter fluid volumes enables rapid “art to part” construction of micro and nanofluidic devices, with potential to dramatically accelerate development of μTAS applications such as integrated High Performance Liquid Chromatography (HPLC) devices, micro scale sensors, and integrated nanopores for patch-clamp studies of cells. The invention makes it possible to form a passage in a monolithic seamless substrate. This is in contrast to conventional laminated structures formed of pre-patterned elements laminated together to form a passage. The substrate of the present invention is preferably of a biocompatible material. The fluid used in the method of the invention is preferably a liquid at machining conditions, preferably nominally room temperature (i.e., 20° C.) and is preferably water or organic.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of forming a microfluidic device comprising:
(a) providing a liquid phase in contact with a substrate;
(b) generating a gas phase from the liquid phase by imparting optical energy to the liquid phase during laser-machining of the substrate; and
(c) transporting machining debris from a vicinity of the substrate by force of the generated gas phase.

2. The method of claim 1, wherein the liquid phase is in contact with an interior of the substrate being laser-machined to form an interior feature.

3. The method of claim 2, wherein an access is laser-machined from a surface of the substrate to the interior and debris is transported from the interior via the access.

4. The method of claim 2, wherein the interior feature comprises at least one of channel, passage and groove.

5. The method of claim 2, and further including inscribing a surface of the substrate to form a surface feature.

6. The method of claim 2, and further including inscribing a surface of the substrate to form a surface feature by laser-machining.

7. The method of claim 2, and further including inscribing a surface of the substrate to form a surface feature by laser-machining in the presence of a liquid phase.

8. The method of claim 5, wherein the surface feature is formed prior to forming the interior feature.

9. The method of claim 5, wherein the surface feature and the interior feature are in communication.

10. The method of claim 1, wherein bubbles of the gas phase have a maximum dimension of less than about 1000 microns.

11. The method of claim 1, wherein bubbles of the gas phase have a maximum dimension of less than about 100 microns.

12. The method of claim 1, wherein bubbles of the gas phase have a maximum dimension of less than 10 microns.

13. The method of claim 1, wherein bubbles of the gas phase have a maximum dimension of about 1-5 microns.

14. The method of claim 1, wherein bubbles of the gas phase have a collapse time of at least 1 millisecond.

15. The method of claim 1, wherein bubbles of the gas phase have a collapse time of at least 10 milliseconds.

16. The method of claim 1, wherein bubbles of the gas phase have a collapse time of at least 50 milliseconds.

17. The method of claim 1, wherein bubbles of the gas phase have a collapse time of about 10-50 milliseconds.

18. A method of forming a microfluidic device comprising:
(a) providing a first fluid phase in contact with the substrate;
(b) generating a second fluid phase from the first fluid phase by imparting optical energy to the first fluid phase during laser-machining of the substrate to form a passage; and
(c) transporting machining debris from a vicinity of the substrate by force of the generated second fluid phase.

19. The method of claim 18, wherein said laser-machining forms a plurality of spaced-apart features created essentially simultaneously by respective multiple foci.

20. The method of claim 18, wherein said laser-machining is at a depth below the surface of the said substrate.

21. The method of claim 18, wherein said laser-machining inscribes a surface of the substrate.
